(19) United States
(12) Patent Application Publication
(10) Pub. No.: US 2026/0223864 A1
(43) Pub. Date: Aug. 6, 2026

(54) BIOCIDE AND BIOPESTICIDE COMPOSITIONS AND METHODS OF CONTROLLING ARTHROPODS

(71) Applicant: PERTINENT SANTÉ ANIMALE, SAS, Haut Mauco (FR)

(72) Inventors: Bruno JACTEL, Brookhaven, GA (US); Ronald HATTON, JR., Raleigh, NC (US); Scott HUBER, Raleigh, NC (US)

(73) Assignee: PERTINENT SANTÉ ANIMALE, SAS, Haut Mauco (FR)

(21) Appl. No.: 19/631,889

(22) Filed: Mar. 27, 2026

Related U.S. Application Data
(63) Continuation-in-part of application No. 17/775,854, filed on Nov. 11, 2020.
(60) Provisional application No. 62/933,867, filed on Nov. 11, 2019.

(51) Int. Cl. A01N 65/44; A01N 25/04; A01N 25/30; A01N 31/16; A01N 65/06; A01N 65/22; A01N 65/24; A01N 65/28; A01P 7/04

(52) U.S. Cl. CPC A01N 65/44; A01N 25/04; A01N 25/30; A01N 31/16; A01N 65/06; A01N 65/22; A01N 65/24; A01N 65/28; A01P 7/04

(57) ABSTRACT

Biocide and biopesticide compositions are provided. The compositions include mixtures of essential oils and carriers, the combined effect of which provides repelling and/or killing effects against arthropod pests and internal parasites. Methods of controlling and treating for arthropod pests and internal parasites using the disclosed compositions are also provided.

### CROSS-REFERENCE TO RELATED APPLICATIONS

This application is a continuation-in-part of U.S. patent application Ser. No. 17/775,854, filed May 10, 2022, which is the United States National Phase patent application of International Patent Application No. PCT/US2020/059999, filed Jan. 11, 2020, which claims the benefit of priority to U.S. Provisional Application No. 62/933,867, filed Nov. 11, 2019, the entire contents of which are incorporated herein by reference.

### TECHNICAL FIELD

This disclosure relates in general to biocide and biopesticide compositions and methods of controlling arthropods and other invertebrates.

### BACKGROUND

It is estimated that by 2050 the world's population will reach 9.1 billion, 34 percent higher than today. In order to feed this larger, more urban, and richer population, food production must increase by 70 percent. Annual cereal production will need to rise to about 3 billion tons from 2.1 billion today and annual meat production will need to rise by over 200 million tons to reach 470 million tons. (1) But the necessary increased in production can be jeopardized by the detrimental impact of pests and parasites. Globally, in total of approximately 9000 species of insects and mites, 50000 species of plant pathogens, and 8000 species of weeds injure crops, of which insect pests caused an estimated 14% of loss. (2)

Therefore, pesticides are used widely in agriculture to improve yields and animal protein production. Their role is to control pests: herbicide, insecticides, nematicide, molluscicide, piscicide, avicide, rodenticide, bactericide, insect repellent, animal repellent, antimicrobial, antiprotozoal, fungicide and parasiticides for the control of internal and external parasites.

In addition, parasiticides are widely used to control Soil Transmitted Helminths in animals and humans. Soil-transmitted helminth infections are among the most common infections worldwide and affect the poorest and most deprived communities. They are transmitted by eggs present in human feces which in turn contaminate soil in areas where sanitation is poor.

According to WHO, more than 1.5 billion people, or 24% of the world's population, are infected with soil-transmitted helminth infections worldwide. Infections are widely distributed in tropical and subtropical areas, with the greatest numbers occurring in sub-Saharan Africa, the Americas, China, and East Asia. Over 267 million preschool-age children and over 568 million school-age children live in areas where these parasites are intensively transmitted and are in need of treatment and preventive interventions. (3)

Besides use in agriculture and human and animal health, pesticides and parasiticides are useful in professional pest control, in home and garden uses, in aquaculture, and in public health.

Chemical pesticides and parasiticides have a high toxicity profile and numerous side effects. Many of the pesticides have been associated with health and environmental issues. The numerous negative health effects that have been associated with chemical pesticides include dermatological, gastrointestinal, neurological, carcinogenic, respiratory, reproductive, and endocrine effects. Furthermore, high occupational, accidental, or intentional exposure to pesticides can result in hospitalization and death. (4) Residues of pesticides can be found in a great variety of everyday foods and beverages. Pesticides residues have also been detected in human breast milk samples, and there are concerns about prenatal exposure and health effects in children.

In addition, just as the effectiveness of antibiotics in the control of human disease is under threat due to the evolution of resistant strains of bacteria, the control of agricultural pests and crop diseases is threatened by the evolution of pesticide resistance, affecting insecticides, herbicides, parasiticides and fungicides. (5)

Therefore, because pesticides have a high toxicity profile and are less efficacious due to increased resistance, there is a need to find alternatives. Once such alternative can in some aspects be referred to as a new class of less toxic pesticides called biocides or biopesticides. What is needed are new biocides, biopesticides or other less toxic pesticides capable of repelling certain animals and insects, and/or killing certain insects and internal parasites. Such pesticides are needed that do not present any known risks to humans or the environment. Such unmet needs are addressed by the instant disclosure.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not To avoid excessive repetition, this Summary does not list or suggest all possible combinations of such features.

In some embodiments provided herein are biocide or biopesticide compositions comprising a blend of one or more essential oils and one or more carriers, the compositions having a repelling and/or killing effect against one or more arthropod pests or internal parasites. Such blends of one or more essential oils are selected from, as examples but not limited to, geraniol, menthol, cornmint oil, peppermint oil, thyme oil, lemongrass oil, phenethylpropionate, rosemary oil, clove oil, cinnamon oil, spearmint oil, eugenol, oregano oil, carvacrol, thymol, citronella oil, citronella, citranellol, cedarwood oil, linalool, carvacrol, para-cymene, alpha-pinene, and/or combinations thereof. Notably, the components of the compositions can have a synergistic effect.

In some aspects, the compositions and formulations can be effective in controlling internal parasites and/or helminths in humans and/or animals. Particularly, in some aspects, the compositions can be effective in controlling helminths in crops.

In some embodiments, provided herein are methods of repelling and/or killing arthropod pests. Such methods can include providing a biocide or biopesticide composition as disclosed herein, and administering the biocide or biopesticide composition to a subject or location in need of treatment The biocide or biopesticide can be administered through a feed or foodstuff consumed by the subject, optionally a human or animal.

Provided are therapeutic compositions for treating an infection or infestation of invertebrate pests, the composition comprising any biocide or biopesticide composition disclosed herein. Provided in some aspects are methods of treating an infection or infestation of invertebrate pests in a subject, the methods comprising administering such a therapeutic composition to a subject in need, optionally wherein the subject is a human or animal subject.

In some aspects, provided are agricultural pesticide compositions comprising a biocide or biopesticide composition as disclosed herein. Correspondingly, methods of treating an infestation of invertebrate pests in an agricultural crop are provided. Such methods can include administering the pesticide composition to an agricultural crop in need, optionally wherein the agricultural crop is a plant or stored grain.

Finally, in some embodiments provided herein are animal feed supplements, the feed supplement comprising a biocide or biopesticide composition disclosed herein. Methods of treating an infestation of invertebrate pests in a domestic animal are provided, where such an animal feed supplement is fed to a livestock or domestic animal in need of treatment. Feeding the animal feed supplement to the domestic animal can treat an infestation of an invertebrate pest in the animal, increase feed efficiency.

In some aspects, the invention relates to an emulsion comprising: a) 0.2 to 10 wt % of geraniol; b) 0.05 to 10 wt % total of one or more essential oils selected from the group consisting of rosemary oil, cornmint oil, eugenol, clove oil, cinnamon oil, spearmint oil, cedarwood oil, peppermint oil, citronella oil, lemongrass oil, and thyme oil; c) 1 to 25 wt % total of a mixture of sodium lauryl sulfate and one or more soaps selected from the group consisting of sodium or potassium salts of one or more of caprylic acid, capric acid, lauric acid, myristic acid, palmitic acid, stearic acid, arachidic acid, caproleic acid, lauroleic acid, myristoleic acid, palmitoleic acid, oleic acid, gadoleic acid, linoleic acid, α-linolenic acid, dihomo-γ-linolenic acid, arachidonic acid, eicosapentaenoic acid, and mixtures thereof; d) 1 to 10 wt % of an organic solvent selected from ethyl lactate and isopropanol; and e) water in an amount sufficient to constitute 100% by weight.

In some embodiments, the emulsion is stable with respect to visual phase separation. In some embodiments, sodium lauryl sulfate and one or more soaps have a synergistic killing effect against one or more pests. In some embodiments, the emulsion comprises equal to or less than 1% by weight of the one or more soaps. In some embodiments, the sodium lauryl sulfate and the mixture of one or more soaps comprise a ratio of 1:3 to 1:6 of sodium lauryl sulfate: one or more soaps.

In some embodiments, the emulsion comprises 1 to 3 wt % of geraniol, 1 to 5 wt % total of the one or more essential oils, 2 to 9 wt % total of the mixture of sodium lauryl sulfate and one or more soaps, 4 to 10 wt % of the organic solvent, and water in an amount sufficient to constitute 100% by weight. In some embodiments, the one or more essential oils are 0.5 to 1.5 wt % cornmint oil and 0.5 to 2 wt % lemongrass oil. In some embodiments, the one or more essential oils are 1 to 3 wt % cornmint oil, 0.25 to 1 wt % eugenol, and 2 to 3 wt % lemongrass oil. In some embodiments, the one or more essential oils are 0.05 wt % eugenol and 0.05 wt % thyme oil. In some embodiments, the one or more essential oils are 0.05 wt % eugenol and 0.05 wt % citronella oil.

In some aspects, the invention further relates to an emulsion comprising: a) 0.2 to 10 wt % of geraniol; b) 0.05 to 5 wt % total of one or more essential oils selected from the group consisting of rosemary oil, cornmint oil, eugenol, clove oil, cinnamon oil, spearmint oil, cedarwood oil, citronella oil, peppermint oil, lemongrass oil, and thyme oil;

c) 1 to 25 wt % of one or more soaps selected from the group consisting of sodium or potassium salts of one or more of caprylic acid, capric acid, lauric acid, myristic acid, palmitic acid, stearic acid, arachidic acid, caproleic acid, lauroleic acid, myristoleic acid, palmitoleic acid, oleic acid, gadoleic acid, linoleic acid, α-linolenic acid, dihomo-γ-linolenic acid, arachidonic acid, and eicosapentaenoic acid; d) 5 to 15 wt % of one or more organic solvent selected from ethyl lactate, glycerin, and isopropanol; and e) water in an amount sufficient to constitute 100% by weight; wherein the emulsion is effective at killing pests, and wherein the emulsion is stable with respect to visual phase separation.

In some embodiments, the one or more essential oils are 0.5 to 3 wt % rosemary oil and 0.25 to 3 wt % cornmint oil. In some embodiments, the one or more essential oils is 0.1 to 1% cornmint oil. In some embodiments, the one or more essential oils are 0.5 to 3 wt % rosemary oil and one or more essential oils in a total amount of 0.5 to 3 wt % of eugenol, spearmint oil, and thyme oil. In some embodiments, the one or more essential oils are 0.05 to 1% cornmint oil and another essential oil in an amount of 0.05 to 3 wt % selected from eugenol, clove oil, cinnamon oil, spearmint oil, cedarwood oil, and citronella oil. In some embodiments, the one or more essential oils is 1 to 3% thyme oil.

In some aspects, the invention relates to an emulsion comprising: a) 0.5 to 5 wt % geraniol; b) 1 to 25 wt % of one or more soaps selected from the group consisting of sodium or potassium salts of caprylic acid, capric acid, lauric acid, myristic acid, palmitic acid, stearic acid, arachidic acid, caproleic acid, lauroleic acid, myristoleic acid, palmitoleic acid, oleic acid, gadoleic acid, linoleic acid, α-linolenic acid, dihomo-γ-linolenic acid, arachidonic acid, and eicosapentaenoic acid; c) 3 to 12 wt % of one or more organic solvent selected from ethyl lactate, glycerin, and isopropanol; and d) water in an amount sufficient to constitute 100% by weight; wherein the emulsion is effective at killing pests, and wherein the emulsion is stable with respect to visual phase separation.

In some embodiments, the one or more organic solvents is a mixture of 1 to 2 wt % ethyl lactate, 7.5 to 8.5% isopropanol, and 1% glycerin. In some embodiments, the one or more organic solvents is 3 to 8 wt % isopropanol.

Accordingly, these and other objects are achieved in whole or in part by the presently disclosed subject matter. Further, objects of the presently disclosed subject matter having been stated above, other objects and advantages of the presently disclosed subject matter will become apparent to those skilled in the art after a study of the following description and Examples.

### DETAILED DESCRIPTION OF THE INVENTION

The presently disclosed subject matter now will be described more fully hereinafter, in which some, but not all embodiments of the presently disclosed subject matter are described. Indeed, the disclosed subject matter can be embodied in many different forms and should not be construed as limited to the embodiments set forth herein; rather, these embodiments are provided so that this disclosure will satisfy applicable legal requirements.

### I Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one skilled in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, mass, weight, temperature, time, volume, concentration, percentage, etc”, is meant to encompass variations of in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A B, C, and D.

The term “arthropods” refers to a Phylum that encompasses insects and acaridae (mites, ticks) as well as spiders, etc. Thus, as used herein, arthropods and insects, used sometimes interchangeably, can refer to any arthropod including, but not limited to, to mites, spiders, and other arachnids, internal parasites, helminths in adult, immature, larvae and egg forms, and like invertebrates. Also, for purposes of this application, the term “insect control” shall refer to having a repellant effect, a pesticidal effect, or both for any arthropod. Moreover, in some embodiments, “insect control” can refer to controlling/repelling arthropods (external parasites) and/or internal parasites (helminths and protozoa).

As used herein, the terms “repel”, “inhibit”, “suppress”, “repress”, “kill”, “control”, “efficacy”, and grammatical variants thereof are used interchangeably and refer to an activity whereby arthropod, invertebrate or insect activity and/or viability is reduced below that observed in the absence of a composition or formulation of the presently disclosed subject matter. In some embodiments, arthropod, invertebrate or insect control that results in repelling or inhibiting activity results in a decrease, e.g. a measurable decrease, in the presence and/or survivability of an arthropod, invertebrate or insect in an environment or on/in a subject, particularly as compared to an untreated environment or subject.

### II. Subjects

In some embodiments a subject treated or administered a disclosed composition is desirably a human subject, although it is to be understood that the principles of the disclosed subject matter indicate that the compositions and methods are effective with respect to invertebrate and to all vertebrate species, including mammals, such as domestic animals, livestock animals, companion animals, rodents, etc., which are intended to be included in the term “subject”. Moreover, a mammal is understood to include any mammalian species in which treatment is desirable, particularly agricultural and domestic mammalian species.

The disclosed methods and treatments are particularly useful in the treatment of warm-blooded vertebrates. Thus, the presently disclosed subject matter concerns mammals and birds.

More particularly, provided herein is the treatment of mammals such as humans, as well as those mammals of importance due to being laboratory animals for modeling human diseases and conditions (such as mice, rats and pigs), endangered (such as Siberian tigers), of economical importance (animals raised on farms for consumption by humans) and/or social importance (animals kept as pets or in zoos) to humans, for instance, carnivores other than humans (such as cats and dogs), swine (pigs, hogs, and wild boars), ruminants (such as cattle, oxen, sheep, giraffes, deer, goats, bison, and camels), and horses. Also provided is the treatment of birds, including the treatment of those kinds of birds that are endangered, kept in zoos, as well as fowl, and more particularly domesticated fowl, i.e., poultry, such as turkeys, chickens, ducks, geese, guinea fowl, and the like, as they are also of economic importance to humans. Also provided is the treatment of fish, including fish in commercial aquaculture operations, as well as ornamental fish in home, professional, and commercial aquaria.

Herein are disclosed methods of repelling, killing, and/or resisting effects of one or more pests, the method comprising administering a composition of the present invention to a subject or location in need of treatment. In some embodiments, the composition acts as a biocide, a pesticide, an insecticide, a nematicide, an anthelminthic, a repellant, or a parasiticide. In some embodiments, the composition is sprayed or misted onto the subject or location in need of treatment. In some embodiments, the pests are selected from a group consisting of arthropods, nematodes, helminths, insect pests, internal parasites, and external parasites.

### III. Discussion

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

Disclosed herein is a series of formulations made of combinations of essential oils with demonstrated activities in multiple species of arthropods, e.g., insects and external parasites, as well as internal parasites, e.g. helminths and protozoa, with potential applications in agriculture, human health and animal health. In some embodiments, the essential oil blends can have a synergistic effect on controlling arthropods and internal parasites.

In some embodiments, provided herein are biocide, biopesticide, or parasiticide compositions, the compositions comprising a blend of one or more essential oils and one or more carriers, the compositions having a repelling and/or killing effect against one or more arthropods, including for example insect pests and internal parasites. In some aspects, such biocide or biopesticide compositions can comprise one or more of thymol, geraniol, linalool, carvacrol, para-cymene, alpha-pinene, menthol, eugenol, carvacrol, citronellal, citronellol, cinnamaldehyde, cinnamol, cornmint oil, peppermint oil, thyme oil, lemongrass oil, rosemary oil, oregano oil, clove oil, citronella oil, cinnamon oil, and/or combinations thereof. In some embodiments, such compositions can further comprise one or more carriers, including for example, but not limited to, white mineral oil, triethyl citrate, isopropyl myristate, sodium bicarbonate, calcium silicate, calcium carbonate, silica, silicon dioxide, diatomaceous earth, celite, water, isopropanol, ethanol, soap, fatty acid salts or esters, sodium lauryl sulfate. In some embodiments, the components of the compositions, including but not limited to essential oils and carriers, can have a synergistic effect in controlling arthropods, external parasites, and other invertebrates. Additionally, such compositions can have a synergistic effective in controlling arthropods, nematodes, helminths, external parasites, internal parasites and/or invertebrate, in humans, animals and/or crops, for professional pest control, for use in homes and gardens, or for use in aquaculture.

In some embodiments, “soap” is any sodium or potassium salts of C6-C10 fatty acids, including but not limited to caprylic acid, capric acid, lauric acid, myristic acid, palmitic acid, stearic acid, arachidic acid, caproleic acid, lauroleic acid, myristoleic acid, palmitoleic acid, oleic acid, gadoleic acid, linoleic acid, α-linolenic acid, dihomo-γ-linolenic acid, arachidonic acid, eicosapentaenoic acid, or any combination thereof. In some embodiments, “soap” is any hydrolysis product of any natural oil, or combinations thereof, as would be obvious to one skilled in the art. In some embodiments, the soaps described herein may be substituted with other soaps as described herein, as would be obvious to one skilled in the art.

In some embodiments, and as described further herein in the Examples and formulations (Tables 1-3), a biocide or biopesticide composition can, for example, comprise geraniol, triethyl citrate and white mineral oil. By way of example only, such compositions can comprise about 3-6% geraniol (e.g. 3%, 4%, 5%, 6% geraniol), 1-4% triethyl citrate (e.g. 1%, 2%, 3%, 4% triethyl citrate) and 90-96% mineral oil, e.g. white mineral oil (e.g. 90%, 91%, 92%, 93%, 94%, 95%, 96% mineral oil). Additionally, by way of example only, such biocide or biopesticide compositions can comprise geraniol, isopropyl myristate and white mineral oil, for example about 3-6% geraniol (e.g. 3%, 4%, 5%, 6% geraniol), 1-4% isopropyl myristate (e.g. 1%, 2%, 3%, 4% isopropyl myristate) and 90-96% mineral oil/white mineral oil (e.g. 90%, 91%, 92%, 93%, 94%, 95%, 96% mineral oil). A complete listing of example formulations and compositions are provided below in Tables 1, 2 and 3.

Where ranges of concentrations are provided herein and in the tables, e.g. 3-8%, all intermediate concentrations, e.g. 3%, 4%, 5%, 6%, 7% and 8%, within the stated range are included and provided herein.

TABLE 1
Example Compositions

| Ingredient | 1 | 2 | 3 | 4 | 5 | 6 | 7 | 8 | 9 | 10 |
|---|---|---|---|---|---|---|---|---|---|---|
| Geraniol | | 0.5-3% | 0.5-3% | 0.5-3% | 13-8% | 13-8% | 0.5-3% | 0.5-3% | 0.5- | 0.5- |
| | | | | | | | | | 3% | 3% |
| Menthol | | | | | | | 0.5-3% | | | |
| Cornmint | | | | | | | | 0.5-3% | 0.5- | |
| oil | | | | | | | | | 3% | |
| Peppermint | | | | | | | | | | 0.5- |
| oil | | | | | | | | | | 3% |
| Thyme oil | | | | | | | | | | |
| Lemongrass | | | | | | | | | | |
| oil | | | | | | | | | | |
| Phenethyl- | | | | | | | | | | |
| propionate | | | | | | | | | | |
| Rosemary | | | | | | | | | | |
| oil | | | | | | | | | | |
| Clove oil | | | | | | | | | | |
| Eugenol | | | | | | | | | | |
| Oregano | | | | | | | | | | |
| oil | | | | | | | | | | |
| Carvacrol | | | | | | | | | | |
| Thymol | | | | | | | | | | |
| Citronella | | | | | | | | | | |
| oil | | | | | | | | | | |
| Citronella | | | | | | | | | | |
| Citranellol | | | | | | | | | | |
| Cedarwood | | | | | | | | | | |
| oil | | | | | | | | | | |
| Sodium | | | | | | | | | | |
| lauryl | | | | | | | | | | |
| sulfate | | | | | | | | | | |
| Lecithin | | | | | | | | | | |
| Polyglyceryl | | | | | | | | | | |
| oleate | | | | | | | | | | |
| Soap | 8-14% | 3-8% | 3-8% | 0.5-3% | 63-8% | 8-14% | 3-8% | 3-8% | 3-8% | 3-8% |
| Sodium | | | | | | | | | | |
| stearate | | | | | | | | | | |
| Potassium | | | | | | | | | | |
| oleate | | | | | | | | | | |
| Potassium | | | | | | | | | | |
| laurate | | | | | | | | | | |
| Isopropyl | | | | | | | | | | |
| myristate | | | | | | | | | | |
| Butyl lactate | | | | | | | | | | |
| Triethyl | | | | | | | | | | |
| citrate | | | | | | | | | | |
| Ethyl lactate | 0.5-3% | | | | | | | | | |
| Glycerin | 0.5-3% | 0.5-3% | 0.5-3% | 0.5-3% | | | 0.5-3% | 0.5-3% | | |
| Isopropanol | 3-8% | 3-8% | 3-8% | 3-8% | 14-20% | | 3-8% | 3-8% | 3-8% | 3-8% |
| Water | 50-80% | 80-90% | 80-90% | 90-95% | | 14-20% | 80-90% | 80-90% | 80- | 80- |
| | | | | | | | | | 90% | 90% |
| Mineral oil | | | | | | 50-80% | | | | |
| Ingredient | 11 | 12 | 13 | 14 | 15 | 16 | 17 | 18 | 19 | 20 |
| Geraniol | 0.5-3% | 0.5-3% | 0.5-3% | 0.5-3% | 0.5-3% | 0.5-3% | 0.5-3% | 0.5-3% | 0.5- | 0.5- |
| | | | | | | | | | 3% | 3% |
| Menthol | | | | | | | | | | |
| Cornmint | | | | | | | | | | |
| oil | | | | | | | | | | |
| Peppermint | | | | | | | | | | |
| oil | | | | | | | | | | |
| Thyme oil | 0.5-3% | 0.5-3% | 0.5-3% | | | | | | | |
| Lemongrass | | | | 0.01-0.5% | | | | | | |
| oil | | | | | | | | | | |
| Phenethyl- | | | | | 0.01-0.5% | | | | | |
| propionate | | | | | | | | | | |
| Rosemary | | | | | | 0.01- | | | | |
| oil | | | | | | 0.5% | | | | |
| Clove oil | | | | | | | 0.01-0.5% | | | |
| Eugenol | | | | | | | | 0.01-0.5% | | |
| Oregano | | | | | | | | | 0.01- | |
| oil | | | | | | | | | 0.5% | |
| Carvacrol | | | | | | | | | | 0.01- |
| Thymol | | | | | | | | | | 0.5% |
| Citronella | | | | | | | | | | |
| oil | | | | | | | | | | |
| Citronella | | | | | | | | | | |
| Citranellol | | | | | | | | | | |
| Cedarwood | | | | | | | | | | |
| oil | | | | | | | | | | |
| Sodium | | | | | | | | | | |
| lauryl | | | | | | | | | | |
| sulfate | | | | | | | | | | |
| Lecithin | | | | | | | | | | |
| Polyglyceryl | | | | | | | | | | |
| oleate | | | | | | | | | | |
| Soap | 3-8% | 3-8% | 0.5-3% | 0.5-3% | 0.5-3% | 0.5-3% | 0.5-3% | 0.5-3% | 0.5- | 0.5- |
| | | | | | | | | | 3% | 3% |
| Sodium | | | | | | | | | | |
| stearate | | | | | | | | | | |
| Potassium | | | | | | | | | | |
| oleate | | | | | | | | | | |
| Potassium | | | | | | | | | | |
| laurate | | | | | | | | | | |
| Isopropyl | | | | | | | | | | |
| myristate | | | | | | | | | | |
| Butyl lactate | | | | | | | | | | |
| Triethyl | | | | | | | | | | |
| citrate | | | | | | | | | | |
| Ethyl lactate | | | | | | | | | | |
| Glycerin | | | | | | | | | | |
| Isopropanol | 3-8% | 3-8% | 3-8% | 3-8% | 3-8% | 3-8% | 3-8% | 3-8% | 3-8% | 3-8% |
| Water | 80-90% | 80-90% | 80-90% | 80-90% | 80-90% | 80-90% | 80-90% | 80-90% | 80- | 80- |
| | | | | | | | | | 90% | 90% |
| Mineral oil | | | | | | | | | | |
| Ingredient | 21 | 22 | 23 | 24 | 25 | 26 | 27 | 28 | 29 | 30 |
| Geraniol | 0.5-3% | 0.5-3% | 0.5-3% | 0.5-3% | 0.5-3% | 0.5-3% | 0.5-3% | 0.5-3% | 0.5- | 0.5- |
| | | | | | | | | | 3% | 3% |
| Menthol | | | | | | | | | | |
| Cornmint | | | | | | | | | | |
| oil | | | | | | | | | | |
| Peppermint | | | | | | | | | | |
| oil | | | | | | | | | | |
| Thyme oil | | | | | | | | | | |
| Lemongrass | | | | | | 0.5-3% | | | | |
| oil | | | | | | | | | | |
| Phenethyl- | | | | | | | 0.5-3% | | | |
| propionate | | | | | | | | | | |
| Rosemary | | | | | | | | 0.5-3% | | |
| oil | | | | | | | | | | |
| Clove oil | | | | | | | | | 0.5- | |
| | | | | | | | | | 3% | |
| Eugenol | | | | | | | | | | 0.5- |
| | | | | | | | | | | 3% |
| Oregano | | | | | | | | | | |
| oil | | | | | | | | | | |
| Carvacrol | | | | | | | | | | |
| Thymol | 0.01-0.5% | | | | | | | | | |
| Citronella | | 0.01-0.5% | | | | | | | | |
| oil | | | | | | | | | | |
| Citronella | | | 0.01-0.5% | | | | | | | |
| Citranellol | | | | 0.01-0.5% | | | | | | |
| Cedarwood | | | | | 0.01-0.5% | | | | | |
| oil | | | | | | | | | | |
| Sodium | | | | | | | | | | |
| lauryl | | | | | | | | | | |
| sulfate | | | | | | | | | | |
| Lecithin | | | | | | | | | | |
| Polyglyceryl | | | | | | | | | | |
| oleate | | | | | | | | | | |
| Soap | 0.5-3% | 0.5-3% | 0.5-3% | 0.5-3% | 0.5-3% | 0.5-3% | 0.5-3% | 0.5-3% | 0.5- | 0.5- |
| | | | | | | | | | 3% | 3% |
| Sodium | | | | | | | | | | |
| stearate | | | | | | | | | | |
| Potassium | | | | | | | | | | |
| oleate | | | | | | | | | | |
| Potassium | | | | | | | | | | |
| laurate | | | | | | | | | | |
| Isopropyl | | | | | | | | | | |
| myristate | | | | | | | | | | |
| Butyl lactate | | | | | | | | | | |
| Triethyl | | | | | | | | | | |
| citrate | | | | | | | | | | |
| Ethyl lactate | | | | | | | | | | |
| Glycerin | | | | | | | | | | |
| Isopropanol | 3-8% | 3-8% | 3-8% | 3-8% | 3-8% | 3-8% | 3-8% | 3-8% | 3-8% | 3-8% |
| Water | 80-90% | 80-90% | 80-90% | 80-90% | 80-90% | 80-90% | 80-90% | 80-90% | 80- | 80- |
| | | | | | | | | | 90% | 90% |
| Mineral oil | | | | | | | | | | |
| Ingredient | 31 | 32 | 33 | 34 | 35 | 36 | 37 | 38 | 39 | 40 |
| Geraniol | 0.5-3% | 0.5-3% | 0.5-3% | 0.5-3% | 0.5-3% | 0.5-3% | 0.5-3% | 0.5-3% | 0.5- | 0.5- |
| | | | | | | | | | 3% | 3% |
| Menthol | | | | | | | | | | |
| Cornmint | | | | | | | | | | |
| oil | | | | | | | | | | |
| Peppermint | | | | | | | | | | |
| oil | | | | | | | | | | |
| Thyme oil | | | | | | | | | | |
| Lemongrass | | | | | | | | 3-8% | | |
| oil | | | | | | | | | | |
| Phenethyl- | | | | | | | | | 3-8% | |
| propionate | | | | | | | | | | |
| Rosemary | | | | | | | | | | 3-8% |
| oil | | | | | | | | | | |
| Clove oil | | | | | | | | | | |
| Eugenol | | | | | | | | | | |
| Oregano | 0.5-3% | | | | | | | | | |
| oil | | | | | | | | | | |
| Carvacrol | | 0.5-3% | | | | | | | | |
| Thymol | | | 0.5-3% | | | | | | | |
| Citronella | | | | 0.5-3% | | | | | | |
| oil | | | | | | | | | | |
| Citronella | | | | | 0.5-3% | | | | | |
| Citranellol | | | | | | 0.5-3% | | | | |
| Cedarwood | | | | | | | 0.5-3% | | | |
| oil | | | | | | | | | | |
| Sodium | | | | | | | | | | |
| lauryl | | | | | | | | | | |
| sulfate | | | | | | | | | | |
| Lecithin | | | | | | | | | | |
| Polyglyceryl | | | | | | | | | | |
| oleate | | | | | | | | | | |
| Soap | 0.5-3% | 0.5-3% | 0.5-3% | 0.5-3% | 0.5-3% | 0.5-3% | 0.5-3% | 0.5-3% | 0.5- | 0.5- |
| | | | | | | | | | 3% | 3% |
| Sodium | | | | | | | | | | |
| stearate | | | | | | | | | | |
| Potassium | | | | | | | | | | |
| oleate | | | | | | | | | | |
| Potassium | | | | | | | | | | |
| laurate | | | | | | | | | | |
| Isopropyl | | | | | | | | | | |
| myristate | | | | | | | | | | |
| Butyl lactate | | | | | | | | | | |
| Triethyl | | | | | | | | | | |
| citrate | | | | | | | | | | |
| Ethyl lactate | | | | | | | | | | |
| Glycerin | | | | | | | | | | |
| Isopropanol | 3-8% | 3-8% | 3-8% | 3-8% | 3-8% | 3-8% | 3-8% | 3-8% | 3-8% | 3-8% |
| Water | 80-90% | 80-90% | 80-90% | 80-90% | 80-90% | 80-90% | 80-90% | 80-90% | 80- | 80- |
| | | | | | | | | | 90% | 90% |
| Mineral oil | | | | | | | | | | |
| Ingredient | 41 | 42 | 43 | 44 | 45 | 46 | 47 | 48 | 49 | 50 |
| Geraniol | 0.5-3% | 0.5-3% | 0.5-3% | 0.5-3% | 0.5-3% | 0.5-3% | 0.5-3% | 0.5-3% | 0.5- | 8- |
| | | | | | | | | | 3% | 14% |
| Menthol | | | | | | | | | | |
| Cornmint | | | | | | | | | | |
| oil | | | | | | | | | | |
| Peppermint | | | | | | | | | | |
| oil | | | | | | | | | | |
| Thyme oil | | | | | | | | | | |
| Lemongrass | | | | | | | | | | |
| oil | | | | | | | | | | |
| Phenethyl- | | | | | | | | | | |
| propionate | | | | | | | | | | |
| Rosemary | | | | | | | | | | |
| oil | | | | | | | | | | |
| Clove oil | 3-8% | | | | | | | | | |
| Eugenol | | 3-8% | | | | | | | | |
| Oregano | | | 3-8% | | | | | | | |
| oil | | | | | | | | | | |
| Carvacrol | | | | 3-8% | | | | | | |
| Thymol | | | | | 3-8% | | | | | |
| Citronella | | | | | | 3-8% | | | | |
| oil | | | | | | | | | | |
| Citronella | | | | | | | 3-8% | | | |
| Citranellol | | | | | | | | 3-8% | | |
| Cedarwood | | | | | | | | | 3-8% | |
| oil | | | | | | | | | | |
| Sodium | | | | | | | | | | |
| lauryl | | | | | | | | | | |
| sulfate | | | | | | | | | | |
| Lecithin | | | | | | | | | | |
| Polyglyceryl | | | | | | | | | | |
| oleate | | | | | | | | | | |
| Soap | 0.5-3% | 0.5-3% | 0.5-3% | 0.5-3% | 0.5-3% | 0.5-3% | 0.5-3% | 0.5-3% | 0.5- | 8- |
| | | | | | | | | | 3% | 14% |
| Sodium | | | | | | | | | | |
| stearate | | | | | | | | | | |
| Potassium | | | | | | | | | | |
| oleate | | | | | | | | | | |
| Potassium | | | | | | | | | | |
| laurate | | | | | | | | | | |
| Isopropyl | | | | | | | | | | 20- |
| myristate | | | | | | | | | | 50% |
| Butyl lactate | | | | | | | | | | |
| Triethyl | | | | | | | | | | |
| citrate | | | | | | | | | | |
| Ethyl lactate | | | | | | | | | | |
| Glycerin | | | | | | | | | | |
| Isopropanol | 3-8% | 3-8% | 3-8% | 3-8% | 3-8% | 3-8% | 3-8% | 3-8% | 3-8% | |
| Water | 80-90% | 80-90% | 80-90% | 80-90% | 80-90% | 80-90% | 80-90% | 80-90% | 80- | 20- |
| | | | | | | | | | 90% | 50% |
| Mineral oil | | | | | | | | | | |
| Ingredient | 51 | 52 | 53 | 54 | 55 | 56 | 57 | 58 | 59 | 60 |
| Geraniol | 20-40% | 0.5-3% | 0.5-3% | 0.5-3% | 3-8% | 0.5-3% | 0.5-3% | 0.5-3% | 20- | 53- |
| | | | | | | | | | 40% | 8% |
| Menthol | | | | | | | | | | |
| Cornmint | | | | | | | | | | |
| oil | | | | | | | | | | |
| Peppermint | | | | | | | | | | |
| oil | | | | | | | | | | |
| Thyme oil | | | 0.5-3% | 0.5-3% | | 0.5-3% | 0.5-3% | 0.5-3% | | |
| Lemongrass | | | | | | | | | | |
| oil | | | | | | | | | | |
| Phenethyl- | | | | | | | | | | |
| propionate | | | | | | | | | | |
| Rosemary | | | | | | | | | | |
| oil | | | | | | | | | | |
| Clove oil | | | | | | | | | | |
| Eugenol | | | | | | | | | | |
| Oregano | | | | | | | | | | |
| oil | | | | | | | | | | |
| Carvacrol | | | | | | | | | | |
| Thymol | | | | | | | | | | |
| Citronella | | | | | | | | | | |
| oil | | | | | | | | | | |
| Citronella | | | | | | | | | | |
| Citranellol | | | | | | | | | | |
| Cedarwood | | | | | | | | | | |
| oil | | | | | | | | | | |
| Sodium | | | | | | | | | 8- | 0.01- |
| lauryl | | | | | | | | | 14% | 0.5% |
| sulfate | | | | | | | | | | |
| Lecithin | | | | | | | | | | 3-8% |
| Polyglyceryl | | | | | | | | | | |
| oleate | | | | | | | | | | |
| Soap | 8-14% | 3-8% | 3-8% | 3-8% | 3-8% | 3-8% | 3-8% | 3-8% | | |
| Sodium | | | | | | | | | | |
| stearate | | | | | | | | | | |
| Potassium | | | | | | | | | | |
| oleate | | | | | | | | | | |
| Potassium | | | | | | | | | | |
| laurate | | | | | | | | | | |
| Isopropyl | | | | | | | | | | |
| myristate | | | | | | | | | | |
| Butyl lactate | | | | | | | | | | 20- |
| | | | | | | | | | | 50% |
| Triethyl | | | | | | | | | | |
| citrate | | | | | | | | | | |
| Ethyl lactate | | | | | | | | | | |
| Glycerin | | | | | | | | | | |
| Isopropanol | | 3-8% | 3-8% | 3-8% | 8-14% | 3-8% | 3-8% | 8-14% | 8- | |
| | | | | | | | | | 14% | |
| Water | 20-50% | 80-90% | 80-90% | 80-90% | 80-90% | 80-90% | 80-90% | 80-90% | 20- | |
| | | | | | | | | | 50% | |
| Mineral oil | 8-14% | | | | | | | | | |
| Ingredient | 61 | 62 | 63 | 64 | 65 | 66 | 67 | 68 | 69 | 70 |
| Geraniol | 0.5-3% | 0.5-3% | 0.5-3% | 3-8% | 0.5-3% | 0.5-3% | 0.5-3% | 0.5-3% | 0.5- | 0.5- |
| | | | | | | | | | 3% | 3% |
| Menthol | | | | | | | | | | |
| Cornmint | | | | | | | | | | |
| oil | | | | | | | | | | |
| Peppermint | | | | | | | | | | |
| oil | | | | | | | | | | |
| Thyme oil | 0.5-3% | 0.5-3% | 0.5-3% | | 0.5-3% | 0.5-3% | 0.5-3% | 0.5-3% | | |
| Lemongrass | | | | | | | | | | |
| oil | | | | | | | | | | |
| Phenethyl- | | | | | | | | | | |
| propionate | | | | | | | | | | |
| Rosemary | | | | | | | | | | |
| oil | | | | | | | | | | |
| Clove oil | | | | | | | | | | |
| Eugenol | | | | | | | | | | |
| Oregano | | | | | | | | | | |
| oil | | | | | | | | | | |
| Carvacrol | | | | | | | | | | |
| Thymol | | | | | | | | | | |
| Citronella | | | | | | | | | | |
| oil | | | | | | | | | | |
| Citronella | | | | | | | | | | |
| Citranellol | | | | | | | | | | |
| Cedarwood | | | | | | | | | | |
| oil | | | | | | | | | | |
| Sodium | | | | | | | | | | |
| lauryl | | | | | | | | | | |
| sulfate | | | | | | | | | | |
| Lecithin | | | | | | | | | | |
| Polyglyceryl | | | | | | | | | | |
| oleate | | | | | | | | | | |
| Soap | 3-8% | 3-8% | 3-8% | 3-8% | 3-8% | 3-8% | 3-8% | 3-8% | 0.5- | 3-8% |
| | | | | | | | | | 3% | |
| Sodium | | | | | | | | | | |
| stearate | | | | | | | | | | |
| Potassium | | | | | | | | | | |
| oleate | | | | | | | | | | |
| Potassium | | | | | | | | | | |
| laurate | | | | | | | | | | |
| Isopropyl | | | | | | | | | | |
| myristate | | | | | | | | | | |
| Butyl lactate | | | | | | | 0.5-3% | 0.5-3% | | |
| Triethyl | | | | | | | | | | |
| citrate | | | | | | | | | | |
| Ethyl lactate | | | | | 0.5-3% | 0.5-3% | | | | |
| Glycerin | 0.5-3% | 0.5-3% | | | | | | | | |
| Isopropanol | 3-8% | 3-8% | 8-14% | 8-14% | 3-8% | 3-8% | 3-8% | 3-8% | 3-8% | 3-8% |
| Water | 80-90% | 80-90% | 50-80% | 80-90% | 50-80% | 80-90% | 50-80% | 80-90% | 90- | 80- |
| | | | | | | | | | 95% | 90% |
| Mineral oil | | | | | | | | | | |
| Ingredient | 71 | 72 | 73 | 74 | 75 | 76 | 77 | 78 | 79 | 80 |
| Geraniol | 0.5-3% | 0.5-3% | 0.5-3% | 0.5-3% | 0.5-3% | 0.5-3% | 0.5-3% | 3-8% | 3-8% | 0.5- |
| | | | | | | | | | | 3% |
| Menthol | | | | | | | | | | |
| Cornmint | | | | | | | | | | |
| oil | | | | | | | | | | |
| Peppermint | | | | | | | | | | |
| oil | | | | | | | | | | |
| Thyme oil | | 0.5-3% | 0.5-3% | | | | | | | |
| Lemongrass | | | | | | | | | | |
| oil | | | | | | | | | | |
| Phenethyl- | | | | | | | | | | |
| propionate | | | | | | | | | | |
| Rosemary | | | | | | | | | | |
| oil | | | | | | | | | | |
| Clove oil | | | | | | | | | | |
| Eugenol | | | | | | | | | | |
| Oregano | | | | | | | | | | |
| oil | | | | | | | | | | |
| Carvacrol | | | | | | | | | | |
| Thymol | | | | | | | | | | |
| Citronella | | | | | | | | | | |
| oil | | | | | | | | | | |
| Citronella | | | | | | | | | | |
| Citranellol | | | | | | | | | | |
| Cedarwood | | | | | | | | | | |
| oil | | | | | | | | | | |
| Sodium | | | | | | | | | | |
| lauryl | | | | | | | | | | |
| sulfate | | | | | | | | | | |
| Lecithin | | | | | | | | | | |
| Polyglyceryl | | | | | | | | | | |
| oleate | | | | | | | | | | |
| Soap | 3-8% | 3-8% | 3-8% | 0.5-3% | 0.5-3% | 3-8% | 0.5-3% | | | |
| Sodium | | | | | | | | | | |
| stearate | | | | | | | | | | |
| Potassium | | | | | | | | | | |
| oleate | | | | | | | | | | |
| Potassium | | | | | | | | | | |
| laurate | | | | | | | | | | |
| Isopropyl | | | | | | | | | 0.5- | 0.5- |
| myristate | | | | | | | | | 3% | 3% |
| Butyl lactate | | | | | | | | | | |
| Triethyl | | | | | | | | 0.5-3% | | |
| citrate | | | | | | | | | | |
| Ethyl lactate | | | | | | | | | | |
| Glycerin | | | | | | | | | | |
| Isopropanol | 3-8% | 3-8% | 3-8% | 3-8% | 3-8% | 3-8% | 3-8% | | | |
| Water | 80-90% | 80-90% | 80-90% | 90-95% | 90-95% | 80-90% | 90-95% | | | |
| Mineral oil | | | | | | | | 90-95% | 90- | 90- |
| | | | | | | | | | 95% | 95% |
| Ingredient | 81 | 82 | 83 | 84 | 85 | 86 | 87 | 88 | 89 | 90 |
| Geraniol | 0.5-3% | 0.01-0.5% | 3-8% | 0.5-3% | 0.5-3% | 0.5-3% | | 0.5-3% | 0.01- | 0.01- |
| | | | | | | | | | 0.5% | 0.5% |
| Menthol | | | | | | | | | | |
| Cornmint | | | | | | | | | | |
| oil | | | | | | | | | | |
| Peppermint | | | | | | | | | | |
| oil | | | | | | | | | | |
| Thyme oil | | | | | | | | | | |
| Lemongrass | | | | | | | | | | |
| oil | | | | | | | | | | |
| Phenethyl- | | | | | | | | | | |
| propionate | | | | | | | | | | |
| Rosemary | | | | | | | | | | |
| oil | | | | | | | | | | |
| Clove oil | | | | | | | | | | |
| Eugenol | | | | | | | | | | |
| Oregano | | | | | | | | | | |
| oil | | | | | | | | | | |
| Carvacrol | | | | | | | | | | |
| Thymol | | | | | | | | | | |
| Citronella | | | | | | | | | | |
| oil | | | | | | | | | | |
| Citronella | | | | | | | | | | |
| Citranellol | | | | | | | | | | |
| Cedarwood | | | | | | | | | | |
| oil | | | | | | | | | | |
| Sodium | | | | | | | | | | |
| lauryl | | | | | | | | | | |
| sulfate | | | | | | | | | | |
| Lecithin | | | | | | | | | | |
| Polyglyceryl | | | | | | | | | | |
| oleate | | | | | | | | | | |
| Soap | | | 8-14% | 8-14% | 8-14% | 8-14% | | | | |
| Sodium | | | | | | | | | | |
| stearate | | | | | | | | | | |
| Potassium | | | | | | | | | | |
| oleate | | | | | | | | | | |
| Potassium | | | | | | | | | | |
| laurate | | | | | | | | | | |
| Isopropyl | 0.5-3% | 0.5-3% | | | | | | | 0.5- | 0.5- |
| myristate | | | | | | | | | 3% | 3% |
| Butyl lactate | | | | | | | | | | |
| Triethyl | | | | | | | | | | |
| citrate | | | | | | | | | | |
| Ethyl lactate | | | 3-8% | 3-8% | 3-8% | 3-8% | | | | |
| Glycerin | | | 0.5-3% | 0.5-3% | 0.5-3% | 0.5-3% | | | | |
| Isopropanol | | | 0.5-3% | 0.5-3% | 0.5-3% | 0.5-3% | 3-8% | 3-8% | | |
| Water | | | | | | | | | | |
| Mineral oil | 95- | 95- | 50-80% | 50-80% | 50-80% | 50-80% | 90-95% | 90-95% | 95- | 95- |
| | 99.99% | 99.99% | | | | | | | 99.99% | 99.99% |
| Ingredient | 91 | 92 | 93 | 94 | 95 | 96 | 97 | 98 | 99 | 100 |
| Geraniol | 8-14% | 0.5-3% | 0.5-3% | | 3-8% | 3-8% | 3-8% | 3-8% | 3-8% | 3-8% |
| Menthol | | | | | | | | | | |
| Cornmint | | | | | | | | | | |
| oil | | | | | | | | | | |
| Peppermint | | | | | | | | | | |
| oil | | | | | | | | | | |
| Thyme oil | | | | | | | | | | |
| Lemongrass | | | | | | | | | | |
| oil | | | | | | | | | | |
| Phenethyl- | | | | | | | | 3-8% | 3-8% | 3-8% |
| propionate | | | | | | | | | | |
| Rosemary | | | | | | | | | | |
| oil | | | | | | | | | | |
| Clove oil | | | | | | | | | | |
| Eugenol | | | | | | | | | | |
| Oregano | | | | | | | | | | |
| oil | | | | | | | | | | |
| Carvacrol | | | | | | | | | | |
| Thymol | | | | | | | | | | |
| Citronella | | | | | | | | | | |
| oil | | | | | | | | | | |
| Citronella | | | | | | | | | | |
| Citranellol | | | | | | | | | | |
| Cedarwood | | | | | | | | | | |
| oil | | | | | | | | | | |
| Sodium | | | | | 3-8% | | | | | |
| lauryl | | | | | | | | | | |
| sulfate | | | | | | | | | | |
| Lecithin | | | | | | 0.5-3% | 0.5-3% | | | |
| Polyglyceryl | | | | | 0.5-3% | 0.5-3% | 0.5-3% | | | |
| oleate | | | | | | | | | | |
| Soap | | | 3-8% | 3-8% | | | | 8-14% | | |
| Sodium | | | | | | | | | | |
| stearate | | | | | | | | | | |
| Potassium | | | | | | | | | | |
| oleate | | | | | | | | | | |
| Potassium | | | | | | | | | | |
| laurate | | | | | | | | | | |
| Isopropyl | 0.5-3% | 0.5-3% | | | | | | | | |
| myristate | | | | | | | | | | |
| Butyl lactate | | | | | | | | | | |
| Triethyl | | | | | 3-8% | | | | | 0.5- |
| citrate | | | | | | | | | | 3% |
| Ethyl lactate | | | | | | | | | | |
| Glycerin | | | | | 3-8% | | 0.5-3% | 0.5-3% | | |
| Isopropanol | | | | | | | | 8-14% | | |
| Water | | | | | 80-90% | 90-95% | 90-95% | 50-80% | | |
| Mineral oil | 80-90% | 90-95% | 90-95% | 90-95% | | | | | 90- | 90- |
| | | | | | | | | | 95% | 95% |
| Ingredient | 101 | 102 | 103 | 104 | 105 | 106 | 107 | 108 | 109 | 110 |
| Geraniol | 3-8% | 3-8% | 3-8% | 0.5-3% | 3-8% | 3-8% | 0.5-3% | 0.5-3% | 0.5- | 0.01- |
| | | | | | | | | | 3% | 0.5% |
| Menthol | | | | | | | | | | |
| Cornmint | | | | | | | | | | |
| oil | | | | | | | | | | |
| Peppermint | | | | | | | | | | |
| oil | | | | | | | | | | |
| Thyme oil | | | | | | | | | | |
| Lemongrass | | | | 0.5-3% | | | | | | |
| oil | | | | | | | | | | |
| Phenethyl- | | | | | | | | | | |
| propionate | | | | | | | | | | |
| Rosemary | | | | | | | | | | |
| oil | | | | | | | | | | |
| Clove oil | | | | | | | | | | |
| Eugenol | | | | | | | | | | |
| Oregano | | | | | | | | | | |
| oil | | | | | | | | | | |
| Carvacrol | | | | | | | | | | |
| Thymol | | | | | | | | | | |
| Citronella | | | | | | | | | | |
| oil | | | | | | | | | | |
| Citronella | | | | | | | | | | |
| Citranellol | | | | | | | | | | |
| Cedarwood | | | | | | | | | | |
| oil | | | | | | | | | | |
| Sodium | 0.5-3% | | | | | | | | | |
| lauryl | | | | | | | | | | |
| sulfate | | | | | | | | | | |
| Lecithin | | | | | | | | | | |
| Polyglyceryl | 0.5-3% | | | | | | | | | |
| oleate | | | | | | | | | | |
| Soap | | | | | | | | | | 0.5- |
| | | | | | | | | | | 3% |
| Sodium | | 10.5-3% | | | | | | | | |
| stearate | | | | | | | | | | |
| Potassium | | | 3-8% | | | | | | | |
| oleate | | | | | | | | | | |
| Potassium | | | | | 8-14% | 8-14% | | | | |
| laurate | | | | | | | | | | |
| Isopropyl | | | | | | | 0.5-3% | 0.5-3% | 0.5-3% | |
| myristate | | | | | | | | | | |
| Butyl lactate | | | | | | | | | | |
| Triethyl | | | | 0.5-3% | | | | | | |
| citrate | | | | | | | | | | |
| Ethyl lactate | 3-8% | | 0.5-3% | | | 0.5-3% | | | | |
| Glycerin | | | 0.5-3% | | 0.5-3% | 0.5-3% | | | | |
| Isopropanol | | 3-8% | 8-14% | | 8-14% | 8-14% | | | | 3-8% |
| Water | 80-90% | 50-80% | 50-80% | | | 50-80% | | | | 90- |
| | | | | | | | | | | 95% |
| Mineral oil | | | | 90-95% | 50-80% | | 90-95% | 95- | 95- | |
| | | | | | | | | 99.99% | 99.99% | |

| Ingredient | 111 |
|---|---|
| Geraniol | 0.01-0.5% |
| Menthol | |
| Cornmint | |
| oil | |
| Peppermint | |
| oil | |
| Thyme oil | |
| Lemongrass | |
| oil | |
| Phenethyl- | |
| propionate | |
| Rosemary | |
| oil | |
| Clove oil | |
| Eugenol | |
| Oregano | |
| oil | |
| Carvacrol | |
| Thymol | |
| Citronella | |
| oil | |
| Citronella | |
| Citranellol | |
| Cedarwood | |
| oil | |
| Sodium | |
| lauryl | |
| sulfate | |
| Lecithin | |
| Polyglyceryl | |
| oleate | |
| Soap | |
| Sodium | |
| stearate | |
| Potassium | |
| oleate | |
| Potassium | |
| laurate | |
| Isopropyl | 0.5-3% |
| myristate | |
| Butyl lactate | |
| Triethyl | |
| citrate | |
| Ethyl lactate | |
| Glycerin | |
| Isopropanol | |
| Water | |
| Mineral oil | 95-99.99% |

TABLE 2
Example compositions

| Ingredient | 112 | 113 | 114 | 115 | 116 | 117 | 118 |
|---|---|---|---|---|---|---|---|
| Geraniol | 3-8% | 3-8% | 3-8% | 3-8% | 3-8% | 3-8% | 3-8% |
| Thyme oil | 3-8% | 3-8% | 3-8% | 3-8% | 3-8% | 3-8% | 3-8% |
| Calcium silicate | 3-8% | 3-8% | 3-8% | 3-8% | 8-14% | 3-8% | 3-8% |
| Calcium carbonate | 3-8% | 8-14% | 14-20% | 20-40% | 8-14% | 3-8% | 3-8% |
| Sodium bicarbonate | 80-90% | 50-80% | 50-80% | 50-80% | 50-80% | 80-90% | 80-90% |

TABLE 3
Example compositions

| Ingredient | 119 | 120 | 121 | 122 | 123 | 124 | 125 | 126 | 127 | 128 | 129 | |
|---|---|---|---|---|---|---|---|---|---|---|---|---|
| Thymol | 100% | | | 50-80% | 50-80% | 50-80% | 50-80% | | | | 20-50% | |
| Linalool | | 100% | | 14-20% | 14-20% | 14-20% | | 14-20% | 14-20% | 14-20% | 14-20% | |
| Carvacrol | | | 100% | | | | 50-80% | 50-80% | 50-80% | 70 | 20-50% | |
| para-Cymene | | | | | 14-20% | | | | 14-20% | | | |
| alpha-Pinene | | | | | | 14-20% | | | | 14-20% | | |
| Sodium | | | | | | | | | | | | |
| caseinate | | | | | | | | | | | | |
| Hydrogenated | | | | | | | | | | | | |
| palm oil | | | | | | | | | | | | |
| Ingredient | 130 | 131 | 132 | 133 | 134 | 135 | 136 | 137 | 138 | 139 | 140 | 141 |
| Thymol | 14-20% | | 8-14% | 8-14% | 8-14% | 8-14% | 3-8% | | | | 8-14% | 8-14% |
| Linalool | | 14-20% | 0.01- | 0.5-3% | 0.5-3% | 0.5-3% | | 0.5-3% | 0.5-3% | 0.5-3% | 3-8% | 3-8% |
| | | | 0.5% | | | | | | | | | |
| Carvacrol | | | | | | 0.01- | 3-8% | 8-14% | 8-14% | 8-14% | 8-14% | 8-14% |
| | | | | | | 0.5% | | | | | | |
| para-Cymene | | | | | 0.5-3% | | | | 0.5-3% | | | |
| alpha-Pinene | | | | | | | | | | 0.5-3% | | |
| Sodium | 80-90% | 50-80% | 80-90% | 80-90% | 80-90% | 80-90% | 80-90% | 80-90% | 80-90% | 80-90% | 50-80% | |
| caseinate | | | | | | | | | | | | |
| Hydrogenated | | | | | | | | | | | | 50-80% |
| palm oil | | | | | | | | | | | | |

In some aspects, the geraniol can comprise any level of purity, including for example geraniol 98%” As a further example, a biocide or biopesticide composition can comprise geraniol 98%, thyme oil, calcium silicate, calcium carbonate, and sodium bicarbonate, optionally about 3-6% geraniol 98%, 3-6% thyme oil, 10-15% calcium silicate, 10-15% calcium carbonate and 64-77% sodium bicarbonate.

Also provided herein are methods of repelling and/or killing arthropods, including insect pests and internal parasites. Such methods can include providing a biocide or biopesticide composition as disclosed herein, and administering the biocide or biopesticide composition to a subject or location in need of treatment In some embodiments, such biocides or biopesticides can be added to feedstuffs or food of animals and humans such that upon consumption by animals and/or humans internal parasites can be treated. For example, such methods can be used on humans, animals (including livestock and/or domesticated pets), and in any location or premises, e.g. agricultural crops, with an arthropod or insect or internal parasite infestation.

In some embodiments, provided herein are biocide and/or biopesticide compositions that are encapsulated (8) and/or configured to be encapsulated. For example, in some embodiments, biocide and/or biopesticide compositions comprising thymol, carvacrol, linalool, etc” can be encapsulated to enhance efficacy.

To elaborate, in some embodiments provided herein are biocide or biopesticide compositions comprising a blend of one or more essential oils and one or more carriers, the compositions having a repelling and/or killing effect against one or more arthropod pests or internal parasites. Such blends of one or more essential oils are selected from, as examples but not limited to, geraniol, menthol, cornmint oil, peppermint oil, thyme oil, lemongrass oil, phenethylpropionate, rosemary oil, clove oil, eugenol, oregano oil, carvacrol, thymol, cinnamon oil, spearmint oil, citronella oil, citronella, citranellol, cedarwood oil, linalool, carvacrol, para-cymene, alpha-pinene, vanillin, and/or combinations thereof. Notably, the components of the compositions can have a synergistic effect.

In some embodiments, the compositions and formulations herein comprise a blend of one or more essential oils at least comprising geraniol. In some such embodiments, geraniol makes up between 0.02 to 10, 0.02 to 9, 0.2 to 8, 0.02 to 7, 0.02 to 6, 0.02 to 5, 0.02 to 4, 0.02 to 3, 0.02 to 2, 0.02 to 1, 0.1 to 10, 0.1 to 9, 0.1 to 8, 0.1 to 7, 0.1 to 6, 0.1 to 5, 0.1 to 4, 0.1 to 3, 0.1 to 2, 0.1 to 1, 0.2 to 10, 0.2 to 9, 0.2 to 8, 0.2 to 7, 0.2 to 6, 0.2 to 5, 0.2 to 4, 0.2 to 3, 0.2 to 2, 0.2 to 1, 1 to 10, 1 to 9, 1 to 8, 1 to 7, 1 to 6, 1 to 5, 1 to 4, 1 to 3, 1 to 2, 1 to 1.5, 1.25 to 10, 1.25 to 9, 1.25 to 8, 1.25 to 7, 1.25 to 6, 1.25 to 5, 1.25 to 4, 1.25 to 3, 1.25 to 2.5, 1.25 to 2, or 1.25 to 1.5 percent by weight of the total composition or formulation.

In some embodiments, the compositions and formulations herein comprise a blend of one or more essential oils at least comprising geraniol, wherein the essential oils in addition to geraniol make up between 0.02 to 10, 0.02 to 9, 0.02 to 8, 0.02 to 7, 0.02 to 6, 0.02 to 5, 0.02 to 4, 0.02 to 3, 0.02 to 2, 0.02 to 1, 0.05 to 10, 0.05 to 9, 0.05 to 8, 0.05 to 7, 0.05 to 6, 0.05 to 5, 0.05 to 4, 0.05 to 3, 0.05 to 2, 0.05 to 1, 0.1 to 10, 0.1 to 9, 0.1 to 8, 0.1 to 7, 0.1 to 6, 0.1 to 5, 0.1 to 4, 0.1 to 3, 0.1 to 2, 0.1 to 1, 0.2 to 10, 0.2 to 9, 0.2 to 8, 0.2 to 7, 0.2 to 6, 0.2 to 5, 0.2 to 4, 0.2 to 3, 0.2 to 2, 0.2 to 1, 1 to 10, 1 to 9, 1 to 8, 1 to 7, 1 to 6, 1 to 5, 1 to 4, 1 to 3, 1 to 2, 1 to 1.5, 1.25 to 10, 1.25 to 9, 1.25 to 8, 1.25 to 7, 1.25 to 6, 1.25 to 5, 1.25 to 4, 1.25 to 3, 1.25 to 2.5, 1.25 to 2, or 1.25 to 1.5 percent by weight of the total composition or formulation.

In some embodiments, the compositions and formulations herein comprise a blend of sodium lauryl sulfate (SLS) and one or more soaps. In some embodiments, “soap” is any sodium or potassium salts of caprylic acid, capric acid, lauric acid, myristic acid, palmitic acid, stearic acid, arachidic acid, caproleic acid, lauroleic acid, myristoleic acid, palmitoleic acid, oleic acid, gadoleic acid, linoleic acid, α-linolenic acid, dihomo-γ-linolenic acid, arachidonic acid, eicosapentaenoic acid, or any combination thereof.

In some embodiments, the compositions and formulations herein comprise a blend of SLS and one or more soaps comprising 0.5 to 25, 0.5 to 20, 0.5 to 15, 0.5 to 10, 0.5 to 9, 0.5 to 8, 0.5 to 7, 0.5 to 6, 0.5 to 5, 0.5 to 4, 0.5 to 3, 0.5 to 2, 0.5 to 1, 1 to 25, 1 to 20, 1 to 15, 1 to 10, 1 to 9, 1 to 8, 1 to 7, 1 to 6, 1 to 5, 1 to 4, 1 to 3, 1 to 2, 2 to 25, 2 to 20, 2 to 15, 2 to 10, 2 to 9, 2 to 8, 2 to 7, 2 to 6, 2 to 5, 2 to 4, or 2 to 3 percent by weight of the total composition or formulation.

In some embodiments, the compositions and formulations herein comprise one or more organic solvents selected from isopropanol, ethyl lactate, glycerin, and isopropyl myristate, wherein the one or more organic solvents comprise 1 to 10, 1 to 9, 1 to 8, 1 to 7, 1 to 6, 1 to, 1 to 4, 1 to 3, or 1 to 2 percent by weight of the total composition or formulation. In some embodiments, the compositions and formulations herein comprise water in an amount sufficient to constitute 100% by weight.

In some embodiments, the blend of SLS and one or more soaps described here have a synergistic effect, as detailed in the Examples of the application.

In some embodiments, the compositions and formulations herein comprise geraniol, one or more essential oils selected from geraniol, menthol, cornmint oil, peppermint oil, thyme oil, lemongrass oil, phenethylpropionate, rosemary oil, clove oil, eugenol, oregano oil, carvacrol, thymol, cinnamon oil, spearmint oil, citronella oil, citronella, citranellol, cedarwood oil, linalool, carvacrol, para-cymene, alpha-pinene, and vanillin, and combinations thereof, sodium lauryl sulfate, one or more soaps, one or more organic solvents selected from isopropanol, ethyl lactate, glycerin, and isopropyl myristate, and water. In some embodiments, the compositions and formulations herein comprise 0.2-10 wt % geraniol, 0.05-10 wt % one or more essential oils selected from geraniol, menthol, cornmint oil, peppermint oil, thyme oil, lemongrass oil, phenethylpropionate, rosemary oil, clove oil, eugenol, oregano oil, carvacrol, thymol, cinnamon oil, spearmint oil, citronella oil, citronella, citranellol, cedarwood oil, linalool, carvacrol, para-cymene, alpha-pinene, and vanillin, and combinations thereof, 1-25 wt % of a mixture of SLS and one or more soaps selected from sodium or potassium salts of caprylic acid, capric acid, lauric acid, myristic acid, palmitic acid, stearic acid, arachidic acid, caproleic acid, lauroleic acid, myristoleic acid, palmitoleic acid, oleic acid, gadoleic acid, linoleic acid, α-linolenic acid, dihomo-γ-linolenic acid, arachidonic acid, eicosapentaenoic acid, or any combination thereof, 1-10 wt % of one or more organic solvents selected from isopropanol, ethyl lactate, glycerin, and isopropyl myristate, and water in an amount sufficient to constitute 100% by weight.

In some embodiments, the compositions and formulations herein comprise additives, wherein the additives are selected from hydroxyethyl cellulose, sodium citrate, triethyl citrate, vanillin, and hydroxypropyl beta-cyclodextrin.

In some embodiments, the compositions and formulations herein are emulsions, wherein the emulsion is stable with respect to visual phase separation. In some embodiments, the inclusion of soap and/or SLS with one or more essential oils, one or more solvents, and optionally water, forms an emulsion. In some embodiments, certain combinations and ratios outlined herein of essential oils, SLS, soap, organic solvent, and water in the amounts described herein was found to be unexpectedly and surprisingly stable with respect to visual phase separation.

In some aspects, the compositions and formulations can be effective in controlling internal parasites and/or helminths in humans and/or animals. Particularly, in some aspects, the compositions can be effective in controlling helminths in crops.

As a specific example, and as discussed in the Examples and shown in Tables 1-3 above, a biocide or biopesticide composition (e.g. formulation 29) can comprise geraniol, clove oil, soap, isopropanol and water, optionally about 0.5% to about 3.0% geraniol, about 0.5% to about 3.0% clove oil, about 0.5% to about 3.0% soap, about 3.0% to about 8.0°/t; isopropanol and about 80.0% to about 90.0% water. As another example, a biocide or biopesticide composition (e.g. formulations 69-77) can comprise geraniol, soap, isopropanol and water, optionally about 0.5% to about 3.0% geraniol, about 0.5% to about 8.0% soap, about 3.0% to about 8.0% isopropanol and about 80.0% to about 95.0% water. A further example (e.g. formulation 78) can comprise geraniol, triethyl citrate and mineral oil, optionally about 3.0% to about 8.0% geraniol, about 0.5% to about 3.0% triethyl citrate and about 90% to about 95% mineral oil (optionally mineral oil). Yet a further composition or formulation (e.g. formulation 79) can include, for example, geraniol, isopropyl myristate and mineral oil, optionally about 3.0% to about 8.0% geraniol, about 0.5% to about 3.0% isopropyl myristate and about 90% to about 95% mineral oil.

In some embodiments, a further example formulation (e.g. formulations 83-86) can comprise geraniol, soap, ethyl lactate, glycerine, isopropanol and mineral oil, optionally about 0.5% to about 8.0% geraniol, about 8.0% to about 14.0% soap, about 3.0% to about 8.0% ethyl lactate, about 0.5% to about 3.0% glycerine, about 0.5% to about 3.0% isopropanol, and about 50% to about 80% mineral oil. Another example (e.g. formulations 107-109) can comprise geraniol, isopropyl myristate and mineral oil, optionally about 3.0% to about 8.0% geraniol, about 0.5% to about 3.0% isopropyl myristate and about 90% to about 95% mineral oil. Another example (e.g. formulation 110) can comprise geraniol, soap, isopropanol and water, optionally about 0.01% to about 0.5°/t; geraniol, about 0.5°/t; to about 3.0% soap, about 3.0% to about 8.0% isopropanol, and about 90% to about 95% water. Another example formulation can comprise (e.g. formulation 111) geraniol, isopropyl myristate and mineral oil, optionally about 0.01% to about 0.5% geraniol, about 0.5% to about 3.0% isopropyl myristate, and about 95.0% to about 99.99% water. Other formulations and compositions not listed above are provided in Tables 1, 2 and 3, and discussed in the Examples.

In some aspects, the biocide or biopesticide compositions comprise geraniol having a purity ranging from about 5% to about 100%. In some aspects, the biocide or biopesticide compositions are in a liquid form, or in a substantially liquid state.

In some aspects, another example composition (e.g. formulations 112-118) can comprise geraniol, thyme oil, calcium silicate, calcium carbonate and sodium bicarbonate, optionally about 3.0 to about 8.0% geraniol, about 3.0% to about 8.0% thyme oil, about 3.0% to about 14% calcium silicate, about 3.0% to about 40% calcium carbonate, and about 50% to about 90% sodium bicarbonate. Such compositions can be a solid, or substantially solid form.

In some aspects, example biocide or biopesticide compositions can comprise one or both of thymol and sodium caseinate, and optionally one or more of linalool, carvacrol, para-cymene, and alpha-pinene. The thymol can be at about 50% to about 100%. Alternatively, the thymol can be at about 3% to about 50%, and sodium caseinate at about 80% to about 90%. In some aspects, the composition can be configured for the treatment of internal parasites in a subject. See, e.g. formulations 119-141 in Table 3.

In some embodiments, provided herein are methods of repelling and/or killing arthropod pests. Such methods can include providing a biocide or biopesticide composition as disclosed herein, and administering the biocide or biopesticide composition to a subject or location in need of treatment. The biocide or biopesticide can be administered through a feed or foodstuff consumed by the subject, optionally a human or animal.

Provided are therapeutic compositions for treating an infection or infestation of invertebrate pests, the composition comprising any biocide or biopesticide composition disclosed herein. Provided in some aspects are methods of treating an infection or infestation of invertebrate pests in a subject, the methods comprising administering such a therapeutic composition to a subject in need, optionally wherein the subject is a human or animal subject.

In some aspects, provided are agricultural pesticide compositions comprising biocide or biopesticide composition as disclosed herein. Correspondingly, methods of treating an infestation of invertebrate pests in an agricultural crop are provided. Such methods can include administering the pesticide composition to an agricultural crop in need, optionally wherein the agricultural crop is a plant or stored grain.

Finally, in some embodiments provided herein are animal feed supplements, the feed supplement comprising a biocide or biopesticide composition disclosed herein. Methods of treating an infestation of invertebrate pests in a domestic animal are provided, where such an animal feed supplement is fed to a livestock or domestic animal in need of treatment. Feeding the animal feed supplement to the domestic animal can treat an infestation of an invertebrate pest in the animal, increase feed efficiency.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

### Example 1

In one embodiment, provided are several blends (Table 1) comprising in a synergistic combinations in various proportions. These combinations have demonstrated efficacy against crawling and flying insects.

When tested Examples 78, 79, 83, 107, 108, 109, and 111 afforded greater than about 90% mortality against beetles (A. diaperinus) when applied to the beetles as a spray.

Likewise, the testing of Examples 78, 79, 83, 84, 85, 86, 107, and 110 afforded greater than about 80% mortality against house flies (M. domestica) when applied to the flies as a spray.

### Example 2

In some embodiments, provided are several blends (Table 1) comprising a synergistic combination in various proportions and combinations. These combinations when tested demonstrated up to 100% efficacy against insects and parasites in agriculture, animal, and human health.

Test materials and compositions were applied to the floor and walls of chicken production houses, infested with litter beetles and their larvae, at a rate of about 20 L to about 40 L per 1,000 m3. Application was completed using a motorized or hand-pump sprayer or mister. Examples 79, 108, and 109 afforded greater than about 90% reduction of litter beetles and larvae, compared to the number of beetles and larvae before treatment.

Test materials and compositions disclosed herein were applied to the air and surfaces in chicken and swine production facilities that were infested with flying insects, including house flies (Musca domestica) and other types of flying insects, at a rate of about 1.5 gallons to about 3 gallons per 1,000 square feet. Examples 74 and 75 provided greater than about 90% reduction of adult flying insects when applied as a spray in infested production facilities

### Example 3

Test compositions and formulations were applied to droppings from chickens and a dose rate of about 0.1 to about 2 weight percent relative to the weight of droppings. The droppings were infested with maggots, and the emergence of adult flies and mortality of emerged flies were measured relative to untreated control groups. Example 129 afforded greater than about 90% control of fly larvae (M. domestica) when applied to infested chicken droppings.

### Example 4

Test compositions and materials were applied to red mites (D. gallnae) in a container at a rate of one spray (sufficient to dampen the mites and surface) with a hand sprayer. Examples 72, 73, 78, 79, 112, 114, and 116 afforded greater than about 90% mortality of red mite.

Test compositions and materials were applied to chicken production facilities infested with red mites, at a rate of about 30 kg to about 60 kg per 1,000 m², using a backpack or handheld duster, sprayer, or mister. Examples 72, 73, 78, 79, and 116 afforded greater than about 80% control of red mites when applied to infested chicken production facilities.

### Example 5

In some embodiments, provided herein are several arthropod, insect and internal parasite control blends comprising a synergistic combination, and in various combinations. Such can be effective in controlling internal parasites (for example, helminths and protozoa) in humans and animals and in controlling parasites and pests in agricultural production. These blends can be encapsulated (8) to enhance efficacy.

In some embodiments, provided herein are blended formulations for use against internal parasites for animals and humans and other pests, including data presented hereinabove. In one embodiment, sporozoites of Eimeria spp. in culture were treated with test materials at a rate of 0.01 to 2 as a weight percent of the culture medium. Examples 119-124 afford >90°/t; control of sporozoites of Eimeria spp.

Chickens were treated with test materials mixed into feed at a dose rate of 20-1000 mg test material per kilogram body weight per day. The treated chickens were inoculated with Eimeria spp. oocysts, and treatment with feed containing the test material was continued for 5-14 days. Examples 130-139 afford up to 25% improvement in feed conversion ratio of in chickens that are infected with Eimeria spp., when compared to infected, untreated chickens.

Eimeria spp. oocysts were isolated in culture and treated with test materials at a rate of 0.01 to 2°h as a percentage of the culture medium. Example 79 affords >70% sporulation of mortality of the Eimeria spp. oocysts.

Roundworms of the genus Ascaris were treated in culture with test materials at a rate of 0.01 to 2% as a percentage of the culture medium. Examples 119-123 afford 100% mortality of Ascaris spp. roundworms in this testing.

### Example 6

Some embodiments the disclosed compositions and formulations can be effective at controlling, by killing or repelling, external parasites of humans and animals.

In one embodiment, cat fleas (C. felis) and sheep ticks (I. ricinus) were treated with test materials by spraying at a rate sufficient to dampen the organisms and surface. Examples 76 and 29 afforded 100% control when sprayed on adult and immature stages of the cat flea (C. felis) and castor bean tick (I. ricinus).

Repellency effect on the product was tested against cat fleas and sheep ticks. Mice were treated with test materials at a rate of 0.01-1 g per 50 g body weight by spraying onto the fur. The mice were placed into a test chamber and the pests released into a connected chamber where they could approach the treated mice. Examples 29 and 76 afforded >80% repellency of the cat flea (C. felis) and sheep tick (I. ricinus) compared to untreated controls.

Bed bugs were treated with test materials by spraying at a rate sufficient to dampen the organisms and surface. Examples 74 and 75 afforded 100% mortality when sprayed on bed bugs (C. lectularius).

### Example 7

Pests of stored gains were treated with test materials by spraying at a rate sufficient to dampen the organisms and surface. Example 79 affords >80% mortality of S. oryzae, R. dominica, and T. castaneum when applied as a spray.

### Example 8

Grape vines were treated with test materials by spraying plants infested with the insect green leafhopper at a rate sufficient to dampen the organisms and leaf surface. Examples 78 and 79 afforded 100% mortality of the green leafhopper.

Winged green aphids and Lygus weevils in petri dishes were treated with test materials by spraying at a rate sufficient to dampen the organisms. Example 77 afforded greater than 70% mortality of aphids and weevils after spraying.

Box tree plants infested with box tree moth were treated with test materials by spraying plants infested with the insect at a rate sufficient to dampen the organisms and leaf surface. Examples 83, 106, and 107 afforded greater than 90% mortality of box tree moth when sprayed on the leaves of box tree plants.

### Example 9

Provided below in Tables 4-5 are a number of working examples of biocide, or pesticide, or parasiticide compositions according to those described in the above description. Tables 4-5 provide non-limiting examples of concentrates according to aspects of the current disclosure. Concentrations of components in the above described Tables are given in ranges according to the present disclosure. These examples are not limiting, but rather show a select number of working examples. Those of ordinary skill in the art should, in light of the present disclosure, appreciate that many changes can be made in the specific embodiments which are disclosed and still obtain a like or similar result without departing from the spirit and scope of the presently disclosed subject matter. Particular exemplary embodiments of percentages by weight are given in parentheses.

TABLE 4

| Ingredient | 1.0 | 1.41 | 1.42 | 1.43 | 1.44 | 1.45 | 1.46 |
|---|---|---|---|---|---|---|---|
| Geraniol | 0.1-10% | 0.1-10% | 0.1-10% | 0.1-10% | 0.1-10% | 0.1-10% | 0.1-10% |
| | (2.50%) | (2.50%) | (2.50%) | (2.50%) | (2.50%) | (2.50%) | (2.50%) |
| Rosemary | | | | | | | |
| oil | | | | | | | |
| Cornmint | 0.1-10% | 0.1-10% | 0.1-10% | 0.1-10% | 0.1-10% | 0.1-10% | 0.1-10% |
| oil | (1.00%) | (1.00%) | (1.00%) | (1.00%) | (1.00%) | (1.00%) | (1.00%) |
| Eugenol | | | | | | | |
| Citronella | | | | | | | |
| oil | | | | | | | |
| Lemongrass | 0.1-10% | 0.1-10% | 0.1-10% | 0.1-10% | 0.1-10% | 0.1-10% | 0.1-10% |
| oil | (1.00%) | (1.00%) | (1.00%) | (1.00%) | (1.00%) | (1.00%) | (1.00%) |
| Thymol | | | | | | | |
| Potassium | 0.1-10% | 0.1-10% | 0.1-10% | 0.1-10% | 0.1-10% | 0.1-10% | 0.1-10% |
| cocoate | (3.00%) | (1.00%) | (1.00%) | (1.00%) | (1.00%) | (1.00%) | (1.00%) |
| Sodium | | | | | | | |
| palmoate | | | | | | | |
| SLS | 0.00% | 0.1-10% | 0.1-10% | 0.1-10% | 0.1-10% | 0.1-10% | 0.1-10% |
| | | (1.00%) | (2.00%) | (3.00%) | (4.00%) | (5.00%) | (6.00%) |
| Ethyl | | | | | | | |
| lactate | | | | | | | |
| Isopropanol | 2-15% | 2-15% | 2-15% | 2-15% | 2-15% | 2-15% | 2-15% |
| | (7.00%) | (7.00%) | (7.00%) | (7.00%) | (7.00%) | (7.00%) | (7.00%) |
| Water | 65-95% | 65-95% | 65-95% | 65-95% | 65-95% | 65-95% | 65-95% |
| | (85.50%) | (84.50%) | (82.50%) | (80.50%) | (78.50%) | (76.50%) | (74.50%) |
| Glycerin | | | | | | | |
| Ingredient | 1.47 | 1.48 | 1.49 | 1.5 | 1.51 | 1.52 | 1.53 |
| Geraniol | 0.1-10% | 0.1-10% | 0.1-10% | 0.1-10% | 0.1-10% | 0.1-10% | 0.1-10% |
| | (2.50%) | (2.50%) | (2.50%) | (2.50%) | (2.50%) | (2.50%) | (2.50%) |
| Rosemary | | | | | | | |
| oil | | | | | | | |
| Cornmint | 0.1-10% | 0.1-10% | 0.1-10% | 0.1-10% | 0.1-10% | 0.1-10% | 0.1-10% |
| oil | (1.00%) | (1.00%) | (1.00%) | (1.00%) | (1.00%) | (1.00%) | (1.00%) |
| Eugenol | | | | | | | |
| Citronella | | | | | | | |
| oil | | | | | | | |
| Lemongrass | 0.1-10% | 0.1-10% | 0.1-10% | 0.1-10% | 0.1-10% | 0.1-10% | 0.1-10% |
| oil | (1.00%) | (1.00%) | (1.00%) | (1.00%) | (1.00%) | (1.00%) | (1.00%) |
| Thymol | | | | | | | |
| Potassium | 0.1-10% | 0.1-10% | 0.1-10% | 0.1-10% | 0.1-10% | 0.1-10% | 0.1-10% |
| cocoate | (1.00%) | (1.00%) | (1.00%) | (1.00%) | (1.00%) | (1.00%) | (1.00%) |
| Sodium | | | | | | | |
| palmoate | | | | | | | |
| SLS | 1-15% | 1-15% | 1-15% | 1-15% | 1-15% | 1-15% | 1-15% |
| | (7.00%) | (8.00%) | (5.00%) | (5.00%) | (5.00%) | (5.00%) | (5.00%) |
| Ethyl | | | | | | | |
| lactate | | | | | | | |
| Isopropanol | 2-15% | 2-15% | 2-15% | 2-15% | 2-15% | 2-15% | 2-15% |
| | (7.00%) | (7.00%) | (4.00%) | (4.50%) | (5.00%) | (6.00%) | (6.50%) |
| Water | 65-95% | 65-95% | 65-95% | 65-95% | 65-95% | 65-95% | 65-95% |
| | (72.50%) | (70.50%) | (79.50%) | (79.00%) | (78.50%) | (77.50%) | (77.00%) |
| Glycerin | | | | | | | |
| Ingredient | 1.54 | 1.55 | | 1.56 | | 1.57 | |
| Geraniol | 0.1-10% | 0.1-10% | | 0.1-10% | | 0.1-10% | |
| | (2.50%) | (2.50%) | | (2.50%) | | (2.50%) | |
| Rosemary oil | | | | | | | |
| Cornmint oil | 0.1-10% | 0.1-10% | | 0.1-10% | | 0.1-10% | |
| | (1.00%) | (1.00%) | | (1.00%) | | (1.00%) | |
| Eugenol | | | | | | | |
| Citronella oil | | | | | | | |
| Lemongrass oil | 0.1-10% | 0.1-10% | | 0.1-10% | | 0.1-10% | |
| | (1.00%) | (1.00%) | | (1.00%) | | (1.00%) | |
| Thymol | | | | | | | |
| Potassium | 0.1-10% | 0.1-10% | | 0.1-10% | | 0.1-10% | |
| cocoate | (1.00%) | (1.00%) | | (1.00%) | | (1.00%) | |
| Sodium palmoate | | | | | | | |
| SLS | 1-15% | 1-15% | | 1-15% | | 1-15% | |
| | (5.00%) | (5.00%) | | (5.00%) | | (5.00%) | |
| Ethyl lactate | | | | | | | |
| Isopropanol | 2-15% | 2-15% | | 2-15% | | 2-15% | |
| | (7.50%) | (8.00%) | | (9.50%) | | (7.00%) | |
| Water | 65-95% | 65-95% | | 65-95% | | 65-95% | |
| | (76.00%) | (75.50%) | | (74.00%) | | (82.50%) | |
| Glycerin | | | | | | | |
| Ingredient | 1.58 | 1.98 | 1.99 | 1.108 | 1.109 | 1.11 | 1.111 |
| Geraniol | 0.1-10% | 0.1-10% | 0.1-10% | | 0.1-10% | 0.1-10% | 0.1-10% |
| | (2.50%) | (1.00%) | (2.00%) | | (1.25%) | (2.50%) | (2.50%) |
| Rosemary oil | | | | | 0.1-10% | | |
| | | | | | (2.00%) | | |
| Cornmint oil | 0.1-10% | | | 0.1-10% | 0.1-10% | 0.1-10% | 0.1-10% |
| | (1.00%) | | | (2.00%) | (0.25%) | (1.00%) | (1.00%) |
| Eugenol | | 0.01-5% | 0.01-5% | 0.01-5% | | | |
| | | (0.05%) | (0.05%) | (0.50%) | | | |
| Citronella oil | | | 0.01-5% | | | | |
| | | | (0.05%) | | | | |
| Lemongrass oil | 0.1-10% | | | 0.1-10% | | 0.1-10% | 0.1-10% |
| | (1.00%) | | | (2.50%) | | (1.50%) | (1.50%) |
| Thymol | | 0.01-5% | | | | | |
| | | (0.05%) | | | | | |
| Potassium | 0.1-10% | 0.1-15% | | 0.1-10% | 0.1-10% | 0.1-10% | 0.1-10% |
| cocoate | (1.00%) | (12.50%) | | (4.00%) | (4.00%) | (1.00%) | (1.00%) |
| Sodium palmoate | | | 0.1-10% | | | | |
| | | | (0.90%) | | | | |
| SLS | 1-15% | 1-15% | 1-15% | 1-15% | 1-15% | 1-15% | 1-15% |
| | (5.00%) | (5.00%) | (5.00%) | (5.00%) | (5.00%) | (5.00%) | (5.00%) |
| Ethyl lactate | 5-15% | | 5-15% | | | | 5-15% |
| | (7.00%) | | (10.00%) | | | | (7.00%) |
| Isopropanol | | 2-15% | | 2-15% | 2-15% | 2-15% | |
| | | (5.00%) | | (10.00%) | (5.00%) | (7.00%) | |
| Water | 65-95% | 65-95% | 65-95% | 65-95% | 65-95% | 65-95% | 65-95% |
| | (82.50%) | (76.40%) | (82.00%) | (76.00%) | (81.50%) | (82.00%) | (82.00%) |
| Glycerin | | | | | 0.1-10% | | |
| | | | | | (1.00%) | | |

### Example 10

Other exemplary formulations are presented in Table 5.

TABLE 5

| Formulation | 1.1 | 1.2 | 1.3 | 1.4 | 1.5 | 1.6 | 1.7 |
|---|---|---|---|---|---|---|---|
| Geraniol | 0.1-10% | 0.1-10% | 0.1-10% | 0.1-10% | 0.1-10% | 0.1-10% | 0.1-10% |
| | (2.50%) | (2.50%) | (2.50%) | (2.50%) | (2.50%) | (0.90%) | (2.50%) |
| Rosemary oil | 0.1-10% | 0.1-10% | 0.1-10% | 0.1-10% | 0.1-10% | | 0.1-10% |
| | (2.00%) | (2.00%) | (2.00%) | (2.00%) | (0.50%) | | (2.00%) |
| Cornmint oil | 0.1-10% | 0.1-10% | 0.1-10% | 0.1-10% | | 0.1-10% | 0.1-10% |
| | (0.50%) | (0.50%) | (0.50%) | (0.50%) | | (0.10%) | (0.50%) |
| Eugenol | | | | | 0.1-10% | | |
| | | | | | (1.00%) | | |
| Clove oil | | | | | | | |
| Cinnamon oil | | | | | | | |
| Spearmint oil | | | | | | | |
| Cedarwood | | | | | | | |
| oil | | | | | | | |
| Citronella oil | | | | | | | |
| Peppermint | | | | | | | |
| oil | | | | | | | |
| Lemongrass | | | | | | | |
| oil | | | | | | | |
| Thyme oil | | | | | | | |
| Potassium | 1-15% | | | | | 1-15% | 1-15% |
| cocoate | (8.00%) | | | | | (5.00%) | (8.00%) |
| Sodium | | | | | | | |
| palmoate | | | | | | | |
| Potassium | | | | | | | |
| laurate | | | | | | | |
| Potassium | | | | | | | |
| caproate/ | | | | | | | |
| capryllate | | | | | | | |
| SLS | | 1-15% | 1-15% | 1-15% | 1-15% | | |
| | | (7.00%) | (7.00%) | (7.00%) | (6.50%) | | |
| Ethyl lactate | | | | | 6.00% | | |
| Isopropanol | 2-15% | 2-15% | 2-15% | 2-15% | | 2-15% | 2-15% |
| | (5.00%) | (5.00%) | (5.00%) | (5.00%) | | (5.00%) | (5.00%) |
| Water | 65-95% | 65-95% | | | 65-95% | 65-95% | 65-95% |
| | (82.00%) | (83.00%) | | | (79.45%) | (89.00%) | (78.00%) |
| Glycerin | | | | | 0.1-10% | | 0.1-10% |
| | | | | | (3.00%) | | (2.00%) |
| Isopropyl | | | | | | | |
| myristate | | | | | | | |
| Mineral oil | | | | | | | |
| Hydroxyethyl | | | 0.1-10% | 0.1-10% | 0.1-10% | | |
| cellulose | | | (1.00%) | (0.50%) | (1.00%) | | |
| Sodium | | | | | 0.01-5% | | |
| citrate | | | | | (0.05%) | | |
| Triethyl | | | | | | | 0.1-10% |
| citrate | | | | | | | (2.00%) |
| Vanillin | | | | | | | |
| Hydroxypropyl | | | | | | | |
| beta- | | | | | | | |
| cyclodextrin | | | | | | | |
| Formulation | 1.8 | 1.9 | 1.10 | 1.11 | 1.12 | 1.13 | 1.14 |
| Geraniol | 0.1-10% | 0.1-10% | 0.1-10% | 0.1-10% | 0.1-10% | 0.1-10% | 0.1-10% |
| | (2.50%) | (2.50%) | (2.50%) | (2.50%) | (2.50%) | (2.50%) | (2.50%) |
| Rosemary | 0.1-10% | 0.1-10% | 0.01-10% | | | 0.01-10% | |
| oil | (2.00%) | (2.00%) | (0.50%) | | | (0.50%) | |
| Cornmint oil | 0.01-10% | 0.01-10% | 0.01-10% | 0.01-10% | 0.01-10% | | 0.01-10% |
| | (0.50%) | (0.50%) | (2.00%) | (0.50%) | (0.50%) | | (0.50%) |
| Eugenol | | | | | | | |
| Clove oil | | | | 0.1-10% | | | |
| | | | | (2.00%) | | | |
| Cinnamon | | | | | 0.1-10% | | |
| oil | | | | | (2.00%) | | |
| Spearmint | | | | | | 0.1-10% | |
| oil | | | | | | (2.00%) | |
| Cedarwood | | | | | | | 0.1-10% |
| oil | | | | | | | (2.00%) |
| Citronella | | | | | | | |
| oil | | | | | | | |
| Peppermint | | | | | | | |
| oil | | | | | | | |
| Lemongrass | | | | | | | |
| oil | | | | | | | |
| Thyme oil | | | | | | | |
| Potassium | 1-15% | | 1-15% | 1-15% | 1-15% | 1-15% | 1-15% |
| cocoate | (8.00%) | | (8.00%) | (8.00%) | (8.00%) | (8.00%) | (8.00%) |
| Sodium | | | | | | | |
| palmoate | | | | | | | |
| Potassium | | | | | | | |
| laurate | | | | | | | |
| Potassium | | 1-15% | | | | | |
| caproate/ | | (8.00%) | | | | | |
| capryllate | | | | | | | |
| SLS | | | | | | | |
| Ethyl lactate | | | | | | | |
| Isopropanol | 1-15% | 1-15% | 1-15% | 1-15% | 1-15% | 1-15% | 1-15% |
| | (10.00%) | (10.00%) | (10.00%) | (10.00%) | (10.00%) | (10.00%) | (10.00%) |
| Water | 65-95% | 65-95% | 65-95% | 65-95% | 65-95% | 65-95% | 65-95% |
| | (75.00%) | (75.00%) | (75.00%) | (75.00%) | (75.00%) | (75.00%) | (75.00%) |
| Glycerin | 0.1-10% | 0.1-10% | 0.1-10% | 0.1-10% | 0.1-10% | 0.1-10% | 0.1-10% |
| | (2.00%) | (2.00%) | (2.00%) | (2.00%) | (2.00%) | (2.00%) | (2.00%) |
| Isopropyl | | | | | | | |
| myristate | | | | | | | |
| Mineral oil | | | | | | | |
| Hydroxyethyl | | | | | | | |
| cellulose | | | | | | | |
| Sodium | | | | | | | |
| citrate | | | | | | | |
| Triethyl | | | | | | | |
| citrate | | | | | | | |
| Vanillin | | | | | | | |
| Hydroxypropyl | | | | | | | |
| beta- | | | | | | | |
| cyclodextrin | | | | | | | |
| Formulation | 1.15 | 1.16 | 1.17 | 1.18 | 1.19 | 1.20 | 1.21 |
| Geraniol | 0.1-10% | | | 0.1-10% | 0.1-10% | 0.1-10% | 0.1-10% |
| | (5.00%) | | | (2.00%) | (2.50%) | (2.50%) | (2.50%) |
| Rosemary | | | 0.1-10% | | 0.1-10% | | 0.1-10% |
| oil | | | (5.00%) | | (2.00%) | | (1.00%) |
| Cornmint oil | | 0.1-10% | | | 0.01-10% | 0.01-10% | 0.01-10% |
| | | (5.00%) | | | (0.50%) | (0.50%) | (0.50%) |
| Eugenol | | | | | | 0.1-10% | |
| | | | | | | (2.00%) | |
| Clove oil | | | | | | | |
| Cinnamon | | | | | | | |
| oil | | | | | | | |
| Spearmint | | | | | | | |
| oil | | | | | | | |
| Cedarwood | | | | | | | |
| oil | | | | | | | |
| Citronella | | | | | | | |
| oil | | | | | | | |
| Peppermint | | | | 0.1-10% | | | |
| oil | | | | (2.00%) | | | |
| Lemongrass | | | | | | | |
| oil | | | | | | | |
| Thyme oil | | | | | | | |
| Potassium | 1-15% | 1-15% | 1-15% | 1-15% | 1-15% | 1-15% | 1-15% |
| cocoate | (8.00%) | (8.00%) | (8.00%) | (8.00%) | (8.00%) | (8.00%) | (8.00%) |
| Sodium | | | | | | | |
| palmoate | | | | | | | |
| Potassium | | | | | | | |
| laurate | | | | | | | |
| Potassium | | | | | | | |
| caproate/ | | | | | | | |
| capryllate | | | | | | | |
| SLS | | | | | | | |
| Ethyl lactate | | | | | | | |
| Isopropanol | 1-15% | 1-15% | 1-15% | 1-15% | 1-15% | 1-15% | 1-15% |
| | (10.00%) | (10.00%) | (10.00%) | (10.00%) | (10.00%) | (10.00%) | (10.00%) |
| Water | 65-95% | 65-95% | 65-95% | 65-95% | 65-95% | 65-95% | 65-95% |
| | (75.00%) | (75.00%) | (75.00%) | (76.00%) | (74.50%) | (75.00%) | (74.50%) |
| Glycerin | 0.1-10% | 0.1-10% | 0.1-10% | 0.1-10% | 0.1-10% | 0.1-10% | |
| | (2.00%) | (2.00%) | (2.00%) | (2.00%) | (2.00%) | (2.00%) | |
| Isopropyl | | | | | | | |
| myristate | | | | | | | |
| Mineral oil | | | | | | | |
| Hydroxyethyl | | | | | | | |
| cellulose | | | | | | | |
| Sodium | | | | | | | |
| citrate | | | | | | | |
| Triethyl | | | | | | | |
| citrate | | | | | | | |
| Vanillin | | | | | 0.01-5% | | 0.01-5% |
| | | | | | (0.50%) | | (0.50%) |
| Hydroxypropyl | | | | | | | |
| beta- | | | | | | | |
| cyclodextrin | | | | | | | |
| Formulation | 1.22 | 1.23 | 1.24 | 1.25 | 1.26 | 1.27 | 1.28 |
| Geraniol | 0.1-10% | 0.1-10% | 0.1-10% | 0.1-10% | 0.1-10% | 0.1-10% | 0.1-10% |
| | (2.50%) | (2.50%) | (2.50%) | (1.50%) | (2.50%) | (2.50%) | (2.50%) |
| Rosemary oil | 0.1-10% | 0.1-10% | 0.1-10% | 0.1-10% | 0.1-10% | 0.1-10% | 0.1-10% |
| | (0.50%) | (2.00%) | (2.00%) | (1.00%) | (2.00%) | (2.00%) | (2.00%) |
| Cornmint oil | | | 0.01-5% | 0.01-5% | 0.01-5% | 0.01-5% | 0.01-5% |
| | | | (0.50%) | (0.50%) | (0.50%) | (0.50%) | (0.50%) |
| Eugenol | 0.1-10% | | | | | | |
| | (1.00%) | | | | | | |
| Clove oil | | | | | | | |
| Cinnamon oil | | | | | | | |
| Spearmint oil | 0.1-10% | 0.01-5% | | | | | |
| | (1.00%) | (0.50%) | | | | | |
| Cedarwood | | | | | | | |
| oil | | | | | | | |
| Citronella oil | | | | | | | |
| Peppermint | | | | | | | |
| oil | | | | | | | |
| Lemongrass | | | | | | | |
| oil | | | | | | | |
| Thyme oil | | | | | | | |
| Potassium | 1-15% | 1-15% | 1-15% | 1-15% | 1-15% | 1-15% | 1-15% |
| cocoate | (8.00%) | (8.00%) | (8.00%) | (1.00%) | (1.00%) | (1.00%) | (1.00%) |
| Sodium | | | | | | | |
| palmoate | | | | | | | |
| Potassium | | | | | | | |
| laurate | | | | | | | |
| Potassium | | | | | | | |
| caproate/ | | | | | | | |
| capryllate | | | | | | | |
| SLS | | | | | | | |
| Ethyl lactate | | | 5-25% | | | 5-25% | |
| | | | (10.00%) | | | (10.00%) | |
| Isopropanol | 1-15% | 1-15% | | 1-15% | 1-15% | | 1-15% |
| | (10.00%) | (10.00%) | | (5.00%) | (10.00%) | | (10.00%) |
| Water | 65-95% | 65-95% | 65-95% | 65-95% | 65-95% | 65-95% | 65-95% |
| | (75.00%) | (75.00%) | (77.00%) | (91.00%) | (84.00%) | (84.00%) | (75.00%) |
| Glycerin | 2.00% | 2.00% | | | | | |
| Isopropyl | | | | | | | |
| myristate | | | | | | | |
| Mineral oil | | | | | | | |
| Hydroxyethyl | | | | | | | |
| cellulose | | | | | | | |
| Sodium | | | | | | | |
| citrate | | | | | | | |
| Triethyl | | | | | | | |
| citrate | | | | | | | |
| Vanillin | | | | | | | |
| Hydroxypropyl | | | | | | | |
| beta- | | | | | | | |
| cyclodextrin | | | | | | | |
| Formulation | 1.29 | 1.30 | 1.31 | 1.32 | 1.33 | 1.34 | 1.35 |
| Geraniol | 0.1-10% | 0.1-10% | 0.1-10% | 0.1-10% | 0.1-10% | 0.1-10% | 0.1-10% |
| | (2.50%) | (2.50%) | (2.50%) | (2.50%) | (2.50%) | (2.50%) | (2.50%) |
| Rosemary | 0.1-10% | 0.1-10% | 0.1-10% | 0.1-10% | 0.1-10% | 0.1-10% | 0.1-10% |
| oil | (2.00%) | (2.00%) | (2.00%) | (2.00%) | (2.00%) | (2.00%) | (2.00%) |
| Cornmint oil | | | 0.01-5% | 0.01-5% | 0.01-5% | 0.01-5% | 0.01-5% |
| | | | (0.50%) | (0.50%) | (0.50%) | (0.50%) | (0.50%) |
| Eugenol | | | | | | | |
| Clove oil | | | | | | | |
| Cinnamon | | | | | | | |
| oil | | | | | | | |
| Spearmint | | | | | | | |
| oil | | | | | | | |
| Cedarwood | | | | | | | |
| oil | | | | | | | |
| Citronella | | | | | | | |
| oil | | | | | | | |
| Peppermint | | | | | | | |
| oil | | | | | | | |
| Lemongrass | | | | | | | |
| oil | | | | | | | |
| Thyme oil | | | | | | | |
| Potassium | 1-15% | 1-15% | 1-15% | 1-15% | 1-15% | 1-15% | 1-15% |
| cocoate | (10.00%) | (10.00%) | (5.00%) | (5.00%) | (5.00%) | (3.00%) | (3.00%) |
| Sodium | | | | | | | |
| palmoate | | | | | | | |
| Potassium | | | | | | | |
| laurate | | | | | | | |
| Potassium | | | | | | | |
| caproate/ | | | | | | | |
| capryllate | | | | | | | |
| SLS | | | | | | | |
| Ethyl lactate | | | | | | | |
| Isopropanol | 1-15% | 1-15% | 1-15% | 1-15% | 1-15% | 1-15% | 1-15% |
| | (8.00%) | (5.00%) | (10.00%) | (8.00%) | (5.00%) | (10.00%) | (8.00%) |
| Water | 65-95% | 65-95% | 65-95% | 65-95% | 65-95% | 65-95% | 65-95% |
| | (77.00%) | (80.00%) | (80.00%) | (82.00%) | (85.00%) | (82.00%) | (84.00%) |
| Glycerin | | | | | | | |
| Isopropyl | | | | | | | |
| myristate | | | | | | | |
| Mineral oil | | | | | | | |
| Hydroxyethyl | | | | | | | |
| cellulose | | | | | | | |
| Sodium | | | | | | | |
| citrate | | | | | | | |
| Triethyl | | | | | | | |
| citrate | | | | | | | |
| Vanillin | | | | | | | |
| Hydroxypropyl | | | | | | | |
| beta- | | | | | | | |
| cyclodextrin | | | | | | | |
| Formulation | 1.36 | 1.37 | 1.38 | 1.39 | 1.40 | 1.59 | 1.60 |
| Geraniol | 0.1-10% | 0.1-10% | 0.1-10% | | 0.1-10% | 0.1-10% | 0.1-10% |
| | (2.50%) | (2.50%) | (2.50%) | | (1.25%) | (5.00%) | (5.00%) |
| Rosemary | 0.1-10% | | | 0.1-10% | 0.1-10% | | |
| oil | (2.00%) | | | (2.00%) | (1.00%) | | |
| Cornmint oil | 0.01-5% | 0.01-5% | 0.01-5% | 0.01-5% | 0.01-5% | | |
| | (0.50%) | (0.50%) | (0.50%) | (0.50%) | (0.50%) | | |
| Eugenol | | | | | | | |
| Clove oil | | | 0.1-10% | | | | |
| | | | (2.00%) | | | | |
| Cinnamon | | | | | | | |
| oil | | | | | | | |
| Spearmint | | | | | | | |
| oil | | | | | | | |
| Cedarwood | | | | | | | |
| oil | | | | | | | |
| Citronella | | | | | | | |
| oil | | | | | | | |
| Peppermint | | | | | | | |
| oil | | | | | | | |
| Lemongrass | | | | 0.1-10% | | | |
| oil | | | | (1.25%) | | | |
| Thyme oil | | | | | | | |
| Potassium | 1-15% | 1-15% | 1-15% | 1-15% | 1-15% | | |
| cocoate | (3.00%) | (8.00%) | (8.00%) | (8.00%) | (4.00%) | | |
| Sodium | | | | | | | |
| palmoate | | | | | | | |
| Potassium | | | | | | | |
| laurate | | | | | | | |
| Potassium | | | | | | | |
| caproate/ | | | | | | | |
| capryllate | | | | | | | |
| SLS | | | | | | | |
| Ethyl lactate | | | | | 1-15% | | |
| | | | | | (5.00%) | | |
| Isopropanol | 1-15% | 1-15% | 1-15% | 1-15% | | | |
| | (5.00%) | (10.00%) | (10.00%) | (10.00%) | | | |
| Water | 65-95% | 65-95% | 65-95% | 65-95% | 65-95% | | |
| | (87.00%) | (79.00%) | (77.00%) | (77.00%) | (88.50%) | | |
| Glycerin | | | | | | | |
| Isopropyl | | | | | | | 0.1-10% |
| myristate | | | | | | | (2.00%) |
| Mineral oil | | | | | | 75-99% | 75-99% |
| | | | | | | (93.00%) | (93.00%) |
| Hydroxyethyl | | | | | | | |
| cellulose | | | | | | | |
| Sodium | | | | | | | |
| citrate | | | | | | | |
| Triethyl | | | | | | 0.1-10% | |
| citrate | | | | | | (2.00%) | |
| Vanillin | | | | | | | |
| Hydroxypropyl | | | | | | | |
| beta- | | | | | | | |
| cyclodextrin | | | | | | | |
| Formulation | 1.61 | 1.62 | 1.63 | 1.64 | 1.65 | 1.66 | 1.67 |
| Geraniol | 0.1-10% | 0.1-10% | 0.1-10% | 0.1-10% | 0.1-10% | 0.1-10% | 0.1-10% |
| | (2.50%) | (1.00%) | (0.50%) | (5.00%) | (5.00%) | (2.50%) | (1.00%) |
| Rosemary oil | | | | | | | |
| Cornmint oil | | | | | | | |
| Eugenol | | | | | | | |
| Clove oil | | | | | | | |
| Cinnamon oil | | | | | | | |
| Spearmint oil | | | | | | | |
| Cedarwood | | | | | | | |
| oil | | | | | | | |
| Citronella oil | | | | | | | |
| Peppermint | | | | | | | |
| oil | | | | | | | |
| Lemongrass | | | | | | | |
| oil | | | | | | | |
| Thyme oil | | | | | | | |
| Potassium | | | | 10-30% | 10-30% | 10-30% | 10-30% |
| cocoate | | | | (25.00%) | (25.00%) | (25.00%) | (25.00%) |
| Sodium | | | | | | | |
| palmoate | | | | | | | |
| Potassium | | | | | | | |
| laurate | | | | | | | |
| Potassium | | | | | | | |
| caproate/ | | | | | | | |
| capryllate | | | | | | | |
| SLS | | | | | | | |
| Ethyl lactate | | | | 0.1-10% | 0.1-10% | 0.1-10% | 0.1-10% |
| | | | | (2.00%) | (2.00%) | (2.00%) | (2.00%) |
| Isopropanol | | | | 1-15% | 1-15% | 1-15% | 1-15% |
| | | | | (7.50%) | (7.50%) | (7.50%) | (7.50%) |
| Water | | | | 50-75% | 50-75% | 50-75% | 50-75% |
| | | | | (59.50%) | (58.50%) | (62.00%) | (63.50%) |
| Glycerin | | | | 0.1-10% | 0.1-10% | 0.1-10% | 0.1-10% |
| | | | | (1.00%) | (1.00%) | (1.00%) | (1.00%) |
| Isopropyl | 0.1-10% | 0.1-10% | 0.1-10% | | | | |
| myristate | (2.00%) | (2.00%) | (2.00%) | | | | |
| Mineral oil | 75-99% | 75-99% | 75-99% | | | | |
| | (95.50%) | (97.00%) | (97.50%) | | | | |
| Hydroxyethyl | | | | | | | |
| cellulose | | | | | | | |
| Sodium | | | | | | | |
| citrate | | | | | | | |
| Triethyl | | | | | | | |
| citrate | | | | | | | |
| Vanillin | | | | | | | |
| Hydroxypropyl | | | | | 0.1-10% | | |
| beta- | | | | | | | |
| cyclodextrin | | | | | (1.00%) | | |
| Formulation | 1.68 | 1.69 | 1.70 | 1.71 | 1.72 | 1.73 | 1.74 |
| Geraniol | 0.1-10% | 0.1-10% | 0.1-10% | 0.1-10% | 0.1-10% | 0.1-10% | 0.1-10% |
| | (0.50%) | (5.00%) | (2.50%) | (2.50%) | (1.00%) | (1.00%) | (0.50%) |
| Rosemary | | | | | | | |
| oil | | | | | | | |
| Cornmint | | | | | | | |
| oil | | | | | | | |
| Eugenol | | | | | | | |
| Clove oil | | | | | | | |
| Cinnamon | | | | | | | |
| oil | | | | | | | |
| Spearmint | | | | | | | |
| oil | | | | | | | |
| Cedarwood | | | | | | | |
| oil | | | | | | | |
| Citronella | | | | | | | |
| oil | | | | | | | |
| Peppermint | | | | | | | |
| oil | | | | | | | |
| Lemongrass oil | | | | | | | |
| Thyme oil | | | | 0.1-10% | 0.1-10% | | |
| | | | | (2.50%) | (1.00%) | | |
| Potassium cocoate | 10-30% | | 1-15% | 1-15% | 1-15% | 1-15% | 1-15% |
| | (25.00%) | | (12.50%) | (12.50%) | (12.50%) | (12.50%) | (12.50%) |
| Sodium palmoate | | | | | | | |
| Potassium laurate | | 1-15% | | | | | |
| | | (10.00%) | | | | | |
| Potassium caproate/ | | | | | | | |
| capryllate | | | | | | | |
| SLS | | | | | | | |
| Ethyl lactate | 0.1-10% | 0.1-10% | | | | | |
| | (2.00%) | (1.00%) | | | | | |
| Isopropanol | 1-15% | 1-15% | 1-15% | 1-15% | 1-15% | 1-15% | 1-15% |
| | (7.50%) | (8.50%) | (7.50%) | (7.50%) | (7.50%) | (5.00%) | (5.00%) |
| Water | 50-95% | 65-95% | 65-95% | 65-95% | 65-95% | 65-95% | 65-95% |
| | (64.00%) | (74.50%) | (77.50%) | (75.00%) | (78.00%) | (81.50%) | (82.00%) |
| Glycerin | 0.1-10% | 0.1-10% | | | | | |
| | (1.00%) | (1.00%) | | | | | |
| Isopropyl myristate | | | | | | | |
| Mineral oil | | | | | | | |
| Hydroxyethyl | | | | | | | |
| cellulose | | | | | | | |
| Sodium | | | | | | | |
| citrate | | | | | | | |
| Triethyl | | | | | | | |
| citrate | | | | | | | |
| Vanillin | | | | | | | |
| Hydroxypropyl | | | | | | | |
| beta-cyclodextrin | | | | | | | |
| Formulation | 1.75 | 1.76 | 1.77 | 1.78 | 1.79 | 1.80 | 1.81 |
| Geraniol | 0.1-10% | 0.01-5% | 0.1-10% | 0.01-5% | 1-15% | 0.1-10% | 0.1-10% |
| | (2.50%) | (0.20%) | (0.50%) | (0.25%) | (10.00%) | (3.00%) | (0.50%) |
| Rosemary | | | | | | | |
| oil | | | | | | | |
| Cornmint | | | | | | | |
| oil | | | | | | | |
| Eugenol | | | | | | | |
| Clove oil | | | | | | | |
| Cinnamon | | | | | | | |
| oil | | | | | | | |
| Spearmint | | | | | | | |
| oil | | | | | | | |
| Cedarwood | | | | | | | |
| oil | | | | | | | |
| Citronella | | | | | | | |
| oil | | | | | | | |
| Peppermint | | | | | | | |
| oil | | | | | | | |
| Lemongrass | | | | | | | |
| oil | | | | | | | |
| Thyme oil | | | | | | | |
| Potassium | 1-15% | | | | | | |
| cocoate | (12.50%) | | | | | | |
| Sodium | | | | | | | |
| palmoate | | | | | | | |
| Potassium | | | | | | | |
| laurate | | | | | | | |
| Potassium | | | | | | | 0.1-10% |
| caproate/ | | | | | | | (2.00%) |
| capryllate | | | | | | | |
| SLS | | | | | | | |
| Ethyl lactate | | | | | | | |
| Isopropanol | 1-15% | 1-15% | 1-15% | | | | 1-15% |
| | (7.00%) | (5.00%) | (5.00%) | | | | (5.00%) |
| Water | 75-95% | 75-99% | 75-99% | | | | 75-99% |
| | (78.00%) | (94.80%) | (94.80%) | | | | (92.50%) |
| Glycerin | | | | | | | |
| Isopropyl | | | | 0.1-10% | 0.1-10% | 0.1-10% | |
| myristate | | | | (2.00%) | (2.00%) | (2.00%) | |
| Mineral oil | | | | 80-99% | 80-99% | 80-99% | |
| | | | | (97.75%) | (88.00%) | (95.00%) | |
| Hydroxyethyl | | | | | | | |
| cellulose | | | | | | | |
| Sodium | | | | | | | |
| citrate | | | | | | | |
| Triethyl | | | | | | | |
| citrate | | | | | | | |
| Vanillin | | | | | | | |
| Hydroxypropyl | | | | | | | |
| beta- | | | | | | | |
| cyclodextrin | | | | | | | |
| Formulation | 1.82 | 1.83 | 1.84 | 1.85 | 1.86 | 1.87 | 1.88 |
| Geraniol | 0.01-5% | 0.1-10% | 0.1-10% | 0.01-5% | | 0.01-5% | 0.1-10% |
| | (0.20%) | (2.00%) | (1.00%) | (0.50%) | | (0.50%) | (1.00%) |
| Rosemary | | | | | | | |
| oil | | | | | | | |
| Cornmint | | | | | | 0.01-5% | |
| oil | | | | | | (0.05%) | |
| Eugenol | | | | | | | 0.01-5% |
| | | | | | | | (0.05%) |
| Clove oil | | | | | | | |
| Cinnamon | | | | | | | |
| oil | | | | | | | |
| Spearmint | | | | | | | |
| oil | | | | | | | |
| Cedarwood | | | | | | | 0.01-5% |
| oil | | | | | | | (0.05%) |
| Citronella | | | | | | 0.01-5% | |
| oil | | | | | | (0.05%) | |
| Peppermint | | | | | | | |
| oil | | | | | | | |
| Lemongrass | | | | | | | |
| oil | | | | | | | |
| Thyme oil | | | | | | | |
| Potassium | | 1-15% | 1-15% | | | | |
| cocoate | | (12.50%) | (2.50%) | | | | |
| Sodium | | | | | | | |
| palmoate | | | | | | | |
| Potassium | | | | | | | |
| laurate | | | | | | | |
| Potassium | 0.1-10% | | | | | | |
| caproate/ | (2.00%) | | | | | | |
| capryllate | | | | | | | |
| SLS | | | | | | | |
| Ethyl | | | | | | | |
| lactate | | | | | | | |
| Isopropanol | 1-15% | 1-15% | 1-15% | | | | |
| | (5.00%) | (5.00%) | (5.00%) | | | | |
| Water | 75-95% | 75-95% | 75-95% | | | | |
| | (92.80%) | (80.50%) | (91.50%) | | | | |
| Glycerin | | | | | | | |
| Isopropyl | | | | | 0.1-10% | 0.1-10% | 0.1-10% |
| myristate | | | | | (2.00%) | (2.00%) | (2.00%) |
| Mineral oil | | | | 90-99.9% | 90-99.9% | 90-99.9% | 90-99.9% |
| | | | | (99.50%) | (98.00%) | (97.40%) | (96.90%) |
| Hydroxyethyl | | | | | | | |
| cellulose | | | | | | | |
| Sodium | | | | | | | |
| citrate | | | | | | | |
| Triethyl | | | | | | | |
| citrate | | | | | | | |
| Vanillin | | | | | | | |
| Hydroxypropyl | | | | | | | |
| beta- | | | | | | | |
| cyclodextrin | | | | | | | |
| Formulation | 1.89 | 1.90 | 1.91 | 1.92 | 1.93 | 1.94 | 1.95 |
| Geraniol | 0.1-10% | 0.1-10% | 0.1-10% | 0.1-10% | 0.1-10% | 0.1-10% | 0.1-10% |
| | (1.00%) | (1.50%) | (1.00%) | (1.50%) | (0.50%) | (2.00%) | (1.00%) |
| Rosemary oil | | | | | | | |
| Cornmint oil | 0.01-5% | | | 0.01-5% | | | |
| | (0.05%) | | | (0.05%) | | | |
| Eugenol | | 0.01-5% | | 0.01-5% | | | |
| | | (0.05%) | | (0.05%) | | | |
| Clove oil | | | | | | | |
| Cinnamon oil | | | | | | | |
| Spearmint oil | | | | | | | |
| Cedarwood oil | | 0.01-5% | 0.01-5% | | | | 0.01-5% |
| | | (0.05%) | (0.05%) | | | | (0.05%) |
| Citronella oil | 0.01-5% | | 0.01-5% | | | | 0.01-5% |
| | (0.05%) | | (0.05%) | | | | (0.05%) |
| Peppermint oil | | | | | | | |
| Lemongrass oil | | | | | | | |
| Thyme oil | | | | | | | |
| Potassium | | | 1-15% | 1-15% | 0.1-15% | | 1-15% |
| cocoate | | | (12.50%) | (12.50%) | (1.00%) | | (12.50%) |
| Sodium | | | | | | | |
| palmoate | | | | | | | |
| Potassium | | | | | | | |
| laurate | | | | | | | |
| Potassium | | | | | | | |
| caproate/ | | | | | | | |
| capryllate | | | | | | | |
| SLS | | | | | | | |
| Ethyl lactate | | | | | | | |
| Isopropanol | | | 1-15% | 1-15% | 1-15% | | 1-15% |
| | | | (5.00%) | (5.00%) | (3.00%) | | (5.00%) |
| Water | | | 65-95% | 65-95% | 65-99% | | 65-95% |
| | | | (81.40%) | (80.90%) | (95.50%) | | (81.40%) |
| Glycerin | | | | | | | |
| Isopropyl | 0.1-10% | 0.1-10% | | | | 0.1-10% | |
| myristate | (2.00%) | (2.00%) | | | | (2.00%) | |
| Mineral oil | 90-99.9% | 90-99.9% | | | | 90-99.9% | |
| | (96.90%) | (96.40%) | | | | (96.00%) | |
| Hydroxyethyl | | | | | | | |
| cellulose | | | | | | | |
| Sodium citrate | | | | | | | |
| Triethyl citrate | | | | | | | |
| Vanillin | | | | | | | |
| Hydroxypropyl | | | | | | | |
| beta- | | | | | | | |
| cyclodextrin | | | | | | | |
| Formulation | 1.96 | 1.97 | 1.100 | 1.101 | 1.102 | 1.103 | 1.104 |
| Geraniol | 0.1-10% | 0.1-10% | | 0.1-10% | 0.1-10% | 0.1-10% | 0.1-10% |
| | (1.00%) | (1.00%) | | (2.00%) | (1.00%) | (0.90%) | (0.90%) |
| Rosemary oil | | | | 0.1-10% | | | |
| | | | | (1.00%) | | | |
| Cornmint oil | 0.01-5% | | | | | 0.01-5% | 0.01-5% |
| | (0.05%) | | | | | (0.10%) | (0.10%) |
| Eugenol | | | | | | | |
| Clove oil | | | | | | | |
| Cinnamon oil | | | | | | | |
| Spearmint oil | | | | | | | |
| Cedarwood oil | | | | | | | |
| Citronella oil | 0.01-5% | | 0.1-10% | | | | |
| | (0.05%) | | (1.00%) | | | | |
| Peppermint oil | | | | | | | |
| Lemongrass oil | | | | | | | |
| Thyme oil | | | | 0.1-10% | 0.1-10% | | |
| | | | | (1.00%) | (1.00%) | | |
| Potassium | 0.1-10% | 0.1-10% | 0.1-10% | 0.1-10% | 0.1-10% | 0.1-10% | 0.1-10% |
| cocoate | (1.00%) | (1.00%) | (1.00%) | (1.00%) | (1.00%) | (1.00%) | (1.00%) |
| Sodium palmoate | | | | | | | |
| Potassium laurate | | | | | | | |
| Potassium | | | | | | | |
| caproate/ | | | | | | | |
| capryllate | | | | | | | |
| SLS | | | | | | | |
| Ethyl lactate | | | | | | | |
| Isopropanol | 1-15% | 1-15% | 1-15% | 1-15% | 1-15% | 1-15% | 1-15% |
| | (7.00%) | (5.00%) | (5.00%) | (5.50%) | (5.50%) | (5.00%) | (7.00%) |
| Water | 75-99% | 75-99% | 75-99% | 75-99% | 75-99% | 75-99% | 75-99% |
| | (90.90%) | (93.00%) | (93.00%) | (85.50%) | (87.50%) | (89.00%) | (87.00%) |
| Glycerin | | | | | | | |
| Isopropyl | | | | | | | |
| myristate | | | | | | | |
| Mineral oil | | | | | | | |
| Hydroxyethyl | | | | | | | |
| cellulose | | | | | | | |
| Sodium citrate | | | | | | | |
| Triethyl citrate | | | | | | | |
| Vanillin | | | | | | | |
| Hydroxypropyl | | | | | | | |
| beta-cyclodextrin | | | | | | | |

| Formulation | 1.105 | 1.106 | 1.107 |
|---|---|---|---|
| Geraniol | 0.1-10% | 0.1-10% | 0.1-10% |
| | (2.50%) | (2.50%) | (2.50%) |
| Rosemary oil | 0.1-10% | | |
| | (2.00%) | | |
| Cornmint oil | 0.01-5% | 0.01-5% | 0.01-5% |
| | (0.50%) | (0.50%) | (0.50%) |
| Eugenol | | | |
| Clove oil | | | 0.1-10% |
| | | | (2.00%) |
| Cinnamon oil | | | |
| Spearmint oil | | | |
| Cedarwood oil | | | |
| Citronella oil | | | |
| Peppermint oil | | | |
| Lemongrass oil | | | |
| Thyme oil | | | |
| Potassium cocoate | 1-15% | 1-15% | 1-15% |
| | (8.00%) | (8.00%) | (8.00%) |
| Sodium palmoate | | | |
| Potassium laurate | | | |
| Potassium caproate/ | | | |
| capryllate | | | |
| SLS | | | |
| Ethyl lactate | | | |
| Isopropanol | 1-15% | 1-15% | 1-15% |
| | (10.00%) | (10.00%) | (10.00%) |
| Water | 65-95% | 65-95% | 65-95% |
| | (75.00%) | (79.00%) | (77.00%) |
| Glycerin | | | |
| Isopropyl myristate | 0.1-10% | | |
| | (2.00%) | | |
| Mineral oil | | | |
| Hydroxyethyl | | | |
| cellulose | | | |
| Sodium citrate | | | |
| Triethyl citrate | | | |
| Vanillin | | | |
| Hydroxypropyl | | | |
| beta-cyclodextrin | | | |

### Example 11

Testing for efficacy against insects (darkling beetle, Alphitobius diaperinus; German cockroach, Blatella germanica; yellow fever mosquito, Aedes aegyptii; and bed bug, Cimex lectularius) was conducted according to the following method. Darkling beetles (3 replicate groups of 10 beetles each) were placed into containers. Beetles in each container were sprayed with Formulation 1.59 at a rate of 100 g/m². After 24 h, 100% of the sprayed beetles were dead. German cockroaches, yellow fever mosquitos, and bed bugs were each killed when sprayed with Formulation 59 as above.

This method was repeated with formulations 1.60-1.111, which afforded 100% mortality of sprayed insects as indicated in Table 6.

TABLE 6

| | Darkling | | Aedes | |
|---|---|---|---|---|
| Formulation | beetle | German cockroach | Egypti | Bed bug |
| 1.59 | + | + | + | + |
| 1.60 | + | + | + | + |
| 1.61 | + | + | + | + |
| 1.62 | + | + | + | + |
| 1.63 | + | + | + | + |
| 1.64 | N/A | + | + | + |
| 1.65 | N/A | + | + | + |
| 1.66 | N/A | + | + | + |
| 1.67 | N/A | + | + | + |
| 1.68 | N/A | + | + | + |
| 1.69 | N/A | + | + | + |
| 1.70 | N/A | + | + | + |
| 1.71 | N/A | + | + | + |
| 1.72 | N/A | + | + | + |
| 1.73 | N/A | + | + | + |
| 1.74 | N/A | + | + | + |
| 1.75 | N/A | + | + | + |
| 1.76 | N/A | + | + | + |
| 1.77 | N/A | + | + | + |
| 1.78 | N/A | + | + | + |
| 1.79 | N/A | + | + | + |
| 1.80 | N/A | + | + | + |
| 1.81 | N/A | + | + | + |
| 1.82 | N/A | + | + | + |
| 1.83 | N/A | + | + | + |
| 1.84 | N/A | + | + | + |
| 1.85 | N/A | + | + | + |
| 1.86 | N/A | + | + | + |
| 1.87 | N/A | + | + | + |
| 1.88 | N/A | + | + | + |
| 1.89 | N/A | + | + | + |
| 1.90 | N/A | + | + | + |
| 1.91 | N/A | + | + | + |
| 1.92 | N/A | + | + | + |
| 1.93 | N/A | + | + | + |
| 1.94 | N/A | + | + | + |
| 1.95 | N/A | + | + | + |
| 1.96 | N/A | + | + | + |
| 1.97 | N/A | + | + | + |
| 1.98 | N/A | + | + | + |
| 1.99 | N/A | + | + | + |
| 1.100 | N/A | + | + | + |
| 1.101 | N/A | + | + | + |
| 1.102 | N/A | + | + | + |
| 1.103 | N/A | + | + | + |
| 1.104 | N/A | + | + | + |
| 1.105 | N/A | + | + | + |
| 1.106 | N/A | + | + | + |
| 1.107 | N/A | + | + | + |
| 1.108 | N/A | + | + | + |
| 1.109 | N/A | + | + | + |
| 1.110 | N/A | + | + | + |
| 1.111 | N/A | + | + | + |

### Example 12

Results of a stability experiment are presented below in Table 7. The items in Table 7 were prepared by mixing together the indicated ingredients and stirring until fully dissolved or until no more dissolution was evident (5-10 minutes) at room temperature (ca. 21° C.). The mixtures were allowed to stand for 24 hours, then observed for cloudiness. The mixtures were then placed in a refrigerator at 2.4° C.; after 24 hours, the mixtures were observed for cloudiness.

“+” indicates a cloudy solution result. “−” indicates clear solution result. “+/−” indicates a slightly cloudy solution result.

TABLE 7

| | 1.0 | 1.41 | 1.42 | 1.43 | 1.44 | 1.45 | 1.46 | 1.47 | 1.48 |
|---|---|---|---|---|---|---|---|---|---|
| Geraniol | 2.50 | 2.50 | 2.50 | 2.50 | 2.50 | 2.50 | 2.50 | 2.50 | 2.50 |
| Cornmint | 1.00 | 1.00 | 1.00 | 1.00 | 1.00 | 1.00 | 1.00 | 1.00 | 1.00 |
| oil | | | | | | | | | |
| Lemon- | 1.00 | 1.00 | 1.00 | 1.00 | 1.00 | 1.00 | 1.00 | 1.00 | 1.00 |
| grass | | | | | | | | | |
| oil | | | | | | | | | |
| Potassium | 3.00 | 1.00 | 1.00 | 1.00 | 1.00 | 1.00 | 1.00 | 1.00 | 1.00 |
| cocoate | | | | | | | | | |
| SLS | 0.00 | 1.00 | 2.00 | 3.00 | 4.00 | 5.00 | 6.00 | 7.00 | 8.00 |
| IPA | 7.00 | 7.00 | 7.00 | 7.00 | 7.00 | 7.00 | 7.00 | 7.00 | 7.00 |
| Water | 85.50 | 84.50 | 82.50 | 80.50 | 78.50 | 76.50 | 74.50 | 72.50 | 70.50 |
| 21° C. | + | + | + | + | +/− | − | − | − | − |
| 2.4° C. | + | + | + | + | + | + | + | − | − |

### Example 13

Results of a synergy experiment are presented below.

The formulations tested herein are described in Table 8 below. PGO indicates polyglyceryl oleate. The ingredients for each formulation were added together and mixed until all solids had dissolved.

Formulation 13.7 is herein referred to as “Base”, referring to the formulation consisting of water, ethyl lactate, and PGO. Other formulations in Table 8 are herein referred to as “Base” plus other added ingredients. For example, 13.2 is “Base+Soap”, 13.3 is “BASE+SLS”, 13.4 is “Base+Geraniol”, 13.5 is “Base+Geraniol+Soap”, and 13.6 is “Base+Geraniol+SLS”.

TABLE 8

| | Ingredient, g | | | | | | |
|---|---|---|---|---|---|---|---|
| | | | | | Sodium | | |
| Form- | | Ethyl | | | lauryl | | |
| ulation | Water | lactate | PGO | Soap | sulfate | Geraniol | Notes |
| 13.1 | 97.75 | 0.43 | 0.1 | 0.3 | 0.44 | 0.98 | |
| 13.2 | 99.17 | 0.43 | 0.1 | 0.3 | | | |
| 13.3 | 99.03 | 0.43 | 0.1 | | 0.44 | | |
| 13.4 | 98.49 | 0.43 | 0.1 | | | 0.98 | Two-phase |
| | | | | | | | mixture |
| 13.5 | 98.19 | 0.43 | 0.1 | 0.3 | | 0.98 | |
| 13.6 | 98.05 | 0.43 | 0.1 | | 0.44 | 0.98 | |
| 13.7 | 99.47 | 0.43 | 0.1 | | | | |

Ten litter beetles were placed into a 60 mm petri dish and treated with 1 mL of test solution. Within 1 minute, the beetles were placed into a clean petri dish with filter paper to absorb excess solution, then into another clean dish and covered. After 2 h, the number of dead, moribund and alive beetles were counted in each dish. This experiment was repeated in triplicate. The results of this experiment are presented in Table 9.
“D” indicates dead (not moving, no response to stimuli)
“M” indicates moribund (barely moving, unable to walk or turn over)
“A” indicates alive (moving as normal)

TABLE 9

| | 13.1 | | | 13.2 | | | 13.3 | | | 13.4 | | | 13.5 | | | 13.6 | | | 13.7 | | |
|---|---|---|---|---|---|---|---|---|---|---|---|---|---|---|---|---|---|---|---|---|---|
| Rep | D | M | A | D | M | A | D | M | A | D | M | A | D | M | A | D | M | A | D | M | A |
| 1 | 10 | | | 2 | 2 | 6 | 3 | 3 | 4 | 5 | 1 | 4 | 7 | 2 | 1 | 7 | 1 | 2 | | | 10 |
| 2 | 10 | | | 2 | 1 | 7 | 3 | 2 | 5 | 6 | 1 | 3 | 7 | 0 | 3 | 8 | 1 | 1 | | | 10 |
| 3 | 10 | | | 3 | 1 | 6 | 3 | 3 | 4 | 6 | 2 | 2 | 6 | 2 | 2 | 7 | 1 | 2 | | | 12 |
| Total | 30 | 0 | 0 | 7 | 4 | 19 | 9 | 8 | 13 | 17 | 4 | 9 | 20 | 4 | 6 | 22 | 3 | 5 | 0 | 0 | 32 |

The percentage dead (% D) and percentage combined dead and moribund (% D+M) were calculated across all repetitions (reps). This is presented in Table 10.

TABLE 10

| | | | | | 13.5 | 13.6 | |
|---|---|---|---|---|---|---|---|
| | | 13.2 | 13.3 | 13.4 | Base + | Base + | |
| | | Base + | Base + | Base + | geraniol + | Geraniol + | 13.7 |
| | 13.1 | Soap | SLS | Geraniol | Soap | SLS | Base |
| D | 30 | 7 | 9 | 17 | 21 | 22 | 0 |
| M | 0 | 4 | 8 | 4 | 3 | 3 | 0 |
| A | 0 | 19 | 13 | 9 | 6 | 5 | 32 |
| S | 30 | 30 | 30 | 30 | 30 | 30 | 32 |
| % D | 100% | 23% | 30% | 57% | 70% | 73% | 0% |
| % (D + M) | 100% | 37% | 57% | 70% | 80% | 83% | 0% |

The percent dead observed (% D [O]), the percent dead expected (% D [E]), also known as expected efficacy, and the ratio of % D [O]/% D [E], also known as the synergistic ratio (R) was calculated and is presented in Table 11. These calculations were performed using Colby's formulae (Colby, Weeds 15 (1): 20-22 (1967)), which is well-known in the art and incorporated herein in its entirety. For binary mixtures, said formula is E=A+B−(AB/100), and for ternary mixtures, said formula is E=A+B+C−((AB+AC+BC)100)−ABC/10,000. A is the % D of the first portion of the mixture. B is the % D of the second portion of the mixture. C is the % D of the third part of the mixture. An R value of >1.00 was observed in Formulations 13.1, 13.6, and 13.7, illustrating the synergistic effects of soap, SLS, and geraniol.

TABLE 11

| Formulation | | % D [O] | % D [E] | R |
|---|---|---|---|---|
| 13.1 | Example Formulation | 100 | 77 | 1.30 |
| 13.2 | Base + Soap | 23 | | |
| 13.3 | Base + SLS | 30 | | |
| 13.4 | Base + Geraniol | 57 | | |
| 13.5 | BASE + Geraniol + | 70 | 67 | 1.05 |
| | Soap | | | |
| 13.6 | Base + Geraniol + | 73 | 70 | 1.04 |
| | SLS | | | |
| 13.7 | Base | 0 | | |

### REFERENCES

All references listed herein including but not limited to all patents, patent applications and publications thereof, scientific journal articles, and database entries are incorporated herein by reference in their entireties to the extent that they supplement, explain, provide a background for, or teach methodology, techniques, and/or compositions employed herein.
1. How to Feed the World in 2050, FAO October 2009.
2. Zhang, W., Global pesticide use: Profile, trend, cost/benefit and more; Proceedings of the International Academy of Ecology and Environmental Sciences, 2018, 8 (1): 1-27
3. Soil-transmitted Helminth Infections, World Health Organization, Mar. 2, 2020.
4. Nicolopoulou-Stamati et al., Chemical Pesticides and Human Health: The Urgent Need for a New Concept in Agriculture, Frontiers in Public Health 2016; 4:148.
5. Hawkins et al., The evolutionary origins of pesticide resistance, Biol Rev Camb Phi/as Soc. 2019 February; 94 (1): 135-155.
6. Isman and Machial, Chapter 2 Pesticides based on plant essential oils: from traditional practice to commercialization, Advances in Phytomedicine, Volume 3, 2006, Pages 29-44
7. Plant Oils Fact Sheet, EPA, 1 Jul. 2001
8. Handbook of Encapsulation of Controlled Release, Munmaya Mishra, editor, CRC Press, 2016.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. An emulsion comprising:
a) 0.2 to 10 wt % of geraniol;
b) 0.05 to 10 wt % total of one or more essential oils selected from the group consisting of rosemary oil, cornmint oil, eugenol, clove oil, cinnamon oil, spearmint oil, cedarwood oil, peppermint oil, citronella oil, lemongrass oil, and thyme oil;
c) 1 to 25 wt % total of a mixture of sodium lauryl sulfate and one or more soaps selected from the group consisting of sodium or potassium salts of one or more of caprylic acid, capric acid, lauric acid, myristic acid, palmitic acid, stearic acid, arachidic acid, caproleic acid, lauroleic acid, myristoleic acid, palmitoleic acid, oleic acid, gadoleic acid, linoleic acid, α-linolenic acid, dihomo-γ-linolenic acid, arachidonic acid, eicosapentaenoic acid, and mixtures thereof;
d) 1 to 10 wt % of an organic solvent selected from ethyl lactate and isopropanol; and
e) water in an amount sufficient to constitute 100% by weight.

2. The emulsion of claim 1, wherein the emulsion is stable with respect to visual phase separation.

3. The emulsion of claim 1, wherein sodium lauryl sulfate and one or more soaps have a synergistic killing effect against one or more pests.

4. The emulsion of claim 1, comprising equal to or less than 1% by weight of the one or more soaps.

5. The emulsion of claim 1, wherein the sodium lauryl sulfate and the mixture of one or more soaps comprise a ratio of 1:3 to 1:6 of sodium lauryl sulfate: one or more soaps.

6. The emulsion of claim 1, comprising 1 to 3 wt % of geraniol, 1 to 5 wt % total of the one or more essential oils, 2 to 9 wt % total of the mixture of sodium lauryl sulfate and one or more soaps, 4 to 10 wt % of the organic solvent, and water in an amount sufficient to constitute 100% by weight.

7. The emulsion of claim 1, wherein the one or more essential oils are 0.5 to 1.5 wt % cornmint oil and 0.5 to 2 wt % lemongrass oil.

8. The emulsion of claim 1, wherein the one or more essential oils are 1 to 3 wt % cornmint oil, 0.25 to 1 wt % eugenol, and 2 to 3 wt % lemongrass oil.

9. The emulsion of claim 1, wherein the one or more essential oils are 0.05 wt % eugenol and 0.05 wt % thyme oil.

10. The emulsion of claim 1, wherein the one or more essential oils are 0.05 wt % eugenol and 0.05 wt % citronella oil.

11. An emulsion comprising:
a) 0.2 to 10 wt % of geraniol;
c) 0.05 to 5 wt % total of one or more essential oils selected from the group consisting of rosemary oil, cornmint oil, eugenol, clove oil, cinnamon oil, spearmint oil, cedarwood oil, citronella oil, peppermint oil, lemongrass oil, and thyme oil;
c) 1 to 25 wt % of one or more soaps selected from the group consisting of sodium or potassium salts of one or more of caprylic acid, capric acid, lauric acid, myristic acid, palmitic acid, stearic acid, arachidic acid, caproleic acid, lauroleic acid, myristoleic acid, palmitoleic acid, oleic acid, gadoleic acid, linoleic acid, α-linolenic acid, dihomo-γ-linolenic acid, arachidonic acid, and eicosapentaenoic acid;
d) 5 to 15 wt % of one or more organic solvent selected from ethyl lactate, glycerin, and isopropanol; and
e) water in an amount sufficient to constitute 100% by weight;
wherein the emulsion is effective at killing pests, and
wherein the emulsion is stable with respect to visual phase separation.

12. The emulsion of claim 17, wherein the one or more essential oils are 0.5 to 3 wt % rosemary oil and 0.25 to 3 wt % cornmint oil.

13. The emulsion of claim 17, wherein the one or more essential oils is 0.1 to 1% cornmint oil.

14. The emulsion of claim 11, wherein the one or more essential oils are 0.5 to 3 wt % rosemary oil and one or more essential oils in a total amount of 0.5 to 3 wt % of eugenol, spearmint oil, and thyme oil.

15. The emulsion of claim 11, wherein the one or more essential oils are 0.05 to 1% cornmint oil and another essential oil in an amount of 0.05 to 3 wt % selected from eugenol, clove oil, cinnamon oil, spearmint oil, cedarwood oil, and citronella oil.

16. The emulsion of claim 11, wherein the one or more essential oils is 1 to 3% thyme oil.

17. An emulsion comprising:
a) 0.5 to 5 wt % geraniol;
b) 1 to 25 wt % of one or more soaps selected from the group consisting of sodium or potassium salts of caprylic acid, capric acid, lauric acid, myristic acid, palmitic acid, stearic acid, arachidic acid, caproleic acid, lauroleic acid, myristoleic acid, palmitoleic acid, oleic acid, gadoleic acid, linoleic acid, α-linolenic acid, dihomo-γ-linolenic acid, arachidonic acid, and eicosapentaenoic acid;
c) 3 to 12 wt % of one or more organic solvent selected from ethyl lactate, glycerin, and isopropanol; and
d) water in an amount sufficient to constitute 100% by weight;
wherein the emulsion is effective at killing pests, and
wherein the emulsion is stable with respect to visual phase separation.

18. The emulsion of claim 18, wherein the one or more organic solvents is a mixture of 1 to 2 wt % ethyl lactate, 7.5 to 8.5% isopropanol, and 1% glycerin.

19. The emulsion of claim 18, wherein the one or more organic solvents is 3 to 8 wt % isopropanol.
